(19) United States
(12) Patent Application Publication
(10) Pub. No.: US 2018/0018735 A1
(43) Pub. Date: Jan. 18, 2018

(54) SYSTEMS AND METHODS FOR ALLOCATING TRADES AMONG TRADING ACCOUNTS

(71) Applicant: Wellington Group Holdings LLP, Boston, MA (US)

(72) Inventor: Amit Partani, Sharon, MA (US)

(21) Appl. No.: 15/628,839

(22) Filed: Jun. 21, 2017

Related U.S. Application Data
(60) Provisional application No. 62/362,910, filed on Jul. 15, 2016.

(51) Int. Cl. G06Q 40/06; G06Q 40/04; G06F 17/18

(52) U.S. Cl. CPC G06Q 40/06; G06F 17/18; G06Q 40/04

(57) ABSTRACT

A system and method are described for determining a distribution, which systematically, automatically and advantageously allocates trades in financial instruments between trading accounts. The method may comprise aggregating orders from accounts and determining a pro-rata allocation of the orders. Based on the determining that there are accounts with a pro-rata share below a minimum amount which will not receive an allocation, the method may update a first allocation, such that the first allocation is equal to or greater than the minimum amount, and a second allocation, such that the second allocation is greater than the minimum amount but less than the pro-rata share for the at least one account. The updating may be based on minimizing a total deviation from the pro-rata allocation of the orders, and maximizing a number of accounts which receive an allocation.

### CROSS-REFERENCE TO RELATED APPLICATIONS

This application is related to U.S. Pat. No. 8,219,481, filed on Dec. 11, 2008, which is incorporated by reference in its entirety. This application claims priority to U.S. Provisional Application No. 62/362,910, filed on Jul. 15, 2016, which is incorporated by reference in its entirety.

### BACKGROUND

Management companies manage large numbers of client accounts of different sizes and perform trades in financial instruments on behalf of these client accounts. Along with the selection of financial instruments, trade execution is a key component of how management companies can generate investment returns for their client accounts. However, allocation of a previously executed trade between client accounts may be difficult, or impossible, and additional trades may be required to allow for allocation between client accounts. Management companies execute trades in financial instruments by aggregating orders from multiple client accounts into an aggregate order. Trades are first executed and then allocated until the aggregate order is either partially filled (<100% of the order is executed) or completely filled (100% of the order is executed). It is advantageous for management companies to be able to quickly allocate an executed trade, given the short time frames for transactions in the financial industry. It would be preferable to allocate trades first and execute the aggregate order second, but this has simply not been done yet. Optimizers have been used to search for the allocation that most closely reflects minimum deviation from a pro-rata distribution but there can be millions of ways to allocate across client accounts and optimizers using brute force to solve for one or more optimization functions subject to constraints can either take too long to be practical, or simply fail to provide a result.

Typically, irrespective of the type of order (e.g., buy, sell, linked, municipal bond new issue), the total order size of an aggregate order is allocated on a pro-rata basis among trading accounts with placed orders for a financial instrument. Pro-rata allocation, which is directly based on order size, may be the most straightforward and is commonly used. However, management companies typically deviate from pro-rata because they must also take into consideration constraints or conditions set by the issuer of the financial instrument, and/or constraints or conditions set by the owners of each client trading account, both of which may constrain the allocation of the total aggregate order size. These additional constraints may frequently conflict with an automated pro-rata determination of allocation, such that one or more manual allocations (relying on heuristics) become necessary. As a result of these manual allocations, some accounts may have a systematically lower probability of having their orders filled, e.g., smaller accounts. For example, in a buy order where the issuer sets a minimum trade size, a client account with a pro-rata order amount falling below the minimum trade size will not be allocated a portion of the trade. It is extremely difficult to systematically and automatically allocate trades between client accounts in a manner which is as close to pro-rata allocation as possible.

### SUMMARY

Systems, devices and methods are described herein for determining a distribution which systematically, automatically and advantageously allocates trades in financial instruments between trading accounts.

As used herein, “pro-rata allocation” refers to an allocation which matches an incoming order for a financial instrument against all placed orders from client accounts having requested a trade in the financial instrument, in proportion to their size. For example, in some embodiments, irrespective of the time sequence in which the orders were entered, a large limit order will receive a large allocation, whereas smaller orders will receive a small allocation, even if entered earlier. A pro-rata allocation may comprise pro-rata quantities.

As used herein, an “allocation” taking place prior to execution refers to a predictive allocation, also referred to as a preliminary allocation.

As used herein, “placed orders” refers to live orders which have been entered into the trading system. For example, certain accounts may have resting or standing orders pending certain conditions, and when the appropriate conditions are met, these resting or standing orders are entered into the trading system and become (live) placed orders.

As used herein, “minimum fill size” refers to the minimum amount an individual client account can be allocated. For example, a minimum fill size may be $200,000 par.

As used herein, “minimum trade size” refers to a minimum trade size which must be allocated. A most common minimum trade size is $200,000 par. For example, financial instruments may have their minimum trade size mandated by their issuers.

As used herein, “incremental size” refers to the permissible increment for trade allocation. Depending on the financial instrument being traded, an allocation can only be split in lots of at least the incremental size. For example, a common incremental size may be $5,000 par. For example, in some embodiments, a management company may adhere to a larger incremental size than the incremental size mandated by the issuer.

As used herein, “remaining quantity restriction” refers to a requirement during a sale that a client account not be allocated a quantity which leaves the client account with a residual sell order with an amount which is less than the minimum trade size. For example, the minimum balance in an order following a partial sale cannot be below the issuer mandated value, typically $200,000 par. For example, for a client account with a sell order of $400,000 par and a minimum trade size of $200,000 par, the client account can only be allocated 0, 200,000 or 400,000.

As used herein, “linked orders” refer to a buy order contingent on a sell order, or vice versa. For example, for linked orders, the management company must ensure that allocations maintain synchronization between buy orders and sell orders across client accounts. For example, when a buy and a sell order are submitted as linked or contingent, the allocation to both the buy and sell must be similar at the account level.

As used herein, “shorts and covers” refer to selling short a security or buying without leaving a residual short position less than minimum trade size. For example, when selling short a financial instrument, a remaining quantity on the order may be less than minimum trade size after the allocation. For example, when buying to cover, after allocation there is no residual short position less than the minimum trade size. For example, sell-shorts may be treated as buys and short-covers may be treated as sells.

As used herein, “MUNI New Issue,” also referred to as “MUNI” refers to a municipal bond new issue offering, which is a debt obligation, issued by a public entity. For example, in some embodiments, MUNI New Issues can include a single CUSIP or multiple CUSIPs with different maturity rates. For example, in MUNI offerings multiple CUSIP's may be offered with separate maturities. For example, MUNIs may have relatively small minimum trade size but may also have account level minimum for any allocations, due to liquidity concerns.

As used herein, “TBAs” refer to “to be announced” orders. For example, TBAs may be similar to MUNI New Issues by having multiple tranches offered as part of an issuance, with high minimum trade sizes mandated by the issuers.

As used herein, “CUSIP” (Committee on Uniform Security Identification Procedures) refers to a 9 digit alphanumeric code used to identify securities.

As used herein, a “fixed income security” is a financial instrument that provides a return in the form of fixed periodic payments and eventual return of principal at maturity. For example, in some embodiments a 5% fixed rate government bond with an initial $1000 investment can generate a $50 yearly dividend until maturity when the buyer of the fixed income security receives the $1000 principal back. For example, in some embodiments, fixed income securities may include corporate debt, government debt, agency debt, municipal debt, mortgage-backed and asset-backed securities and various combinations of these. For example, fixed income trades may include stand-alone buy and sell orders, new issues, linked trades, etc.

According to one aspect, a method for allocating trades in a financial instrument between client accounts, includes determining, using processing circuitry, a financial instrument for a trade, determining, using the processing circuitry, a plurality of accounts for trading in the financial instrument, and aggregating, using the processing circuitry, orders for the financial instrument from the plurality of accounts. The method also includes determining, using the processing circuitry, a pro-rata allocation of the orders for the financial instrument, from the plurality of accounts, and determining whether there are accounts, from the plurality of accounts, with a pro-rata share below a minimum amount. The method further includes, based on the determining that there are accounts, from the plurality of accounts, with a pro-rata share below a minimum amount: determining, using the processing circuitry, a first number of accounts, from the plurality of accounts, with a pro-rata share below a minimum amount which will not receive an allocation, and updating, using the processing circuitry at least one of a first allocation and a second allocation. An update to a first allocation for at least one account, from the plurality of accounts, with a pro-rata share below the minimum amount which will receive an allocation, is such that the first allocation is equal to or greater than the minimum amount. An update to a second allocation for at least one account, from the plurality of accounts, with a pro-rata share greater than the minimum amount, is such that the second allocation is greater than the minimum amount but less than the pro-rata share for the at least one account. The updating is based on minimizing a total deviation from the pro-rata allocation of the orders for the financial instrument, and maximizing a number of accounts which receive an allocation.

In some embodiments, the method further includes computing a first contribution to the total deviation, from the first number of accounts, from the plurality of accounts, with a pro-rata share below a minimum amount which will not receive an allocation. The method also includes computing a second contribution to the total deviation from the at least one account, from the plurality of accounts, with a pro-rata share greater than the minimum amount, and computing a third contribution to the total deviation which is an absolute value of the first contribution to the total deviation minus the second contribution to the total deviation. The method further includes determining a fourth contribution to the total deviation which is equal to a set amount when the second contribution minus the first contribution is strictly greater than an amount available for allocation from accounts, of the plurality of accounts, with a pro-rata share above the minimum amount, and which is equal to zero otherwise, and selecting the first number such that a sum of the first contribution, the second contribution, the third contribution, and the fourth contribution is minimized.

In some embodiments, the method includes determining whether the trade is a sell, and based on the determining that the trade is a sell, performing the updating such that for each of the accounts which receive an allocation, an amount of orders remaining after allocation is greater than the minimum amount.

In some embodiments, the method includes determining whether the financial instrument is a Municipal New Issue Bond, and based on the determining that the financial instrument is a Municipal New Issue Bond, determining a number of CUSIPs available for allocation. The method also includes determining whether an allocation to one of the plurality of accounts of the number of CUSIPs available is possible. The method also includes, based on determining that the allocation to one of the plurality of accounts of the number of CUSIPs available is possible: accessing a database linking account level minimums to break points, determining account level minimums for the plurality of accounts, based on the accessing and the determined account level minimums, and performing the updating such that a number of unique CUSIP and account combinations is minimized.

In some embodiments, the method includes transmitting, using the processing circuitry, an allocation of the orders for the financial instrument to a trading system for execution.

In some embodiments, the processing circuitry is part of an allocation module located on a first server, and wherein the trading system is located on a second server.

In some embodiments, the updating is based on multiple executions, such that a fill size of the trade is maximized.

In some embodiments, the method further includes based on the determining that there are accounts, from the plurality of accounts, with a pro-rata share below a minimum amount, transmitting to an optimization module constraints associated with the financial instrument, the plurality of accounts for trading and associated constraints. The method also includes receiving from the optimization module a number of accounts, from the plurality of accounts with a pro-rata share below the minimum amount, for which an allocation will be updated, and receiving from the optimization module a number of accounts, from the plurality of accounts with a pro-rata share greater than the minimum amount, for which an allocation will be updated.

In some embodiments, minimizing a total deviation from the pro-rata allocation of the orders for the financial instrument, and the maximizing a number of accounts which receive an allocation are based on multiple allocations.

In some embodiments, the method further comprises a first plurality of allocations, wherein the first allocation and the second allocation belong to the first plurality of allocations associated with the plurality of accounts. The method may further include receiving, by the processing circuitry, a second plurality of allocations associated with the plurality of accounts. The method may include calculating, using the processing circuitry, a plurality of differences between the first plurality of allocations and the second plurality of allocations and comparing, using the processing circuitry, each of the plurality of differences to a threshold. If a difference of the plurality of differences exceeds the threshold, the method may generate a notification signal.

According to another aspect, a system for allocating trades in a financial instrument between client accounts, includes a database and processing circuitry. The processing circuitry is configured to determine a financial instrument for a trade, determine a plurality of accounts for trading in the financial instrument, aggregate orders for the financial instrument from the plurality of accounts, and determine a pro-rata allocation of the orders for the financial instrument, from the plurality of accounts. The processing circuitry is further configured to determine whether there are accounts, from the plurality of accounts, with a pro-rata share below a minimum amount, and based on the determining that there are accounts, from the plurality of accounts, with a pro-rata share below a minimum amount: to determine a first number of accounts, from the plurality of accounts, with a pro-rata share below a minimum amount which will not receive an allocation, and to update at least one of a first and second allocation. The first allocation for at least one account, from the plurality of accounts, with a pro-rata share below the minimum amount which will receive an allocation, is such that the first allocation is equal to or greater than the minimum amount. The second allocation for at least one account, from the plurality of accounts, with a pro-rata share greater than the minimum amount, is such that the second allocation is greater than the minimum amount but less than the pro-rata share for the at least one account. The updating is based on minimizing a total deviation from the pro-rata allocation of the orders for the financial instrument, and maximizing a number of accounts which receive an allocation.

In some embodiments, the processing circuitry configured to determine, using the processing circuitry, the first number of accounts, from the plurality of accounts, with a pro-rata share below a minimum amount which will not receive an allocation, is further configured to compute a first contribution to the total deviation, from the first number of accounts, from the plurality of accounts, with a pro-rata share below a minimum amount which will not receive an allocation. The processing circuitry is also configured to compute a second contribution to the total deviation from the at least one account, from the plurality of accounts, with a pro-rata share greater than the minimum amount, and to compute a third contribution to the total deviation which is an absolute value of the first contribution to the total deviation minus the second contribution to the total deviation. The processing circuitry is further configured to determine a fourth contribution to the total deviation which is equal to a set amount when the second contribution minus the first contribution is strictly greater than an amount available for allocation from accounts, of the plurality of accounts, with a pro-rata share above the minimum amount, and which is equal to zero otherwise, and to select the first number such that a sum of the first contribution, the second contribution, the third contribution, and the fourth contribution is minimized.

In some embodiments, the processing circuitry is further configured to determine whether the trade is a sell, and based on the determining that the trade is a sell, perform the updating such that for each of the accounts which receive an allocation, an amount of orders remaining after allocation is greater than the minimum amount.

In some embodiments, the processing circuitry is further configured to determine whether the financial instrument is a Municipal New Issue Bond, based on the determining that the financial instrument is a Municipal New Issue Bond, determine a number of CUSIPs available for allocation, and to determine whether an allocation to one of the plurality of accounts of the number of CUSIPs available is possible. The control circuitry is further configured, based on determining that the allocation to one of the plurality of accounts of the number of CUSIPs available is possible, to access a database linking account level minimums to break points, to determine account level minimums for the plurality of accounts, and based on the accessing and the determined account level minimums, perform the updating such that a number of unique CUSIP and account combinations is minimized.

In some embodiments, the processing circuitry is further configured to transmit, using the processing circuitry, an allocation of the orders for the financial instrument to a trading system for execution.

In some embodiments, the processing circuitry is part of an allocation module located on a first server, and wherein the trading system is located on a second server.

In some embodiments, the updating is based on multiple executions, such that a fill size of the trade is maximized.

In some embodiments, the processing circuitry is configured to determine that there are accounts, from the plurality of accounts, with a pro-rata share below a minimum amount is further configured to transmit to an optimization module constraints associated with the financial instrument, the plurality of accounts for trading and associated constraints. The processing circuitry is further configured to receive from the optimization module a number of accounts, from the plurality of accounts with a pro-rata share below the minimum amount, for which an allocation will be updated, and to receive from the optimization module a number of accounts, from the plurality of accounts with a pro-rata share greater than the minimum amount, for which an allocation will be updated.

In some embodiments, minimizing a total deviation from the pro-rata allocation of the orders for the financial instrument, and the maximizing a number of accounts which receive an allocation are based on multiple allocations.

In some embodiments, the system further comprises a first plurality of allocations, wherein the first allocation and the second allocation belong to the first plurality of allocations associated with the plurality of accounts. The processing circuitry may be further configured to receive, by the processing circuitry, a second plurality of allocations associated with the plurality of accounts. The processing circuitry may be further configured to calculate, using the processing circuitry, a plurality of differences between the first plurality of allocations and the second plurality of allocations and comparing, using the processing circuitry, each of the plurality of differences to a threshold. The processing circuitry may be further configured to generate a notification signal based on whether a difference of the plurality of differences exceeds the threshold.

### BRIEF DESCRIPTION OF THE DRAWINGS

The foregoing and other features and advantages will be apparent upon consideration of the following detailed description, taken in conjunction with the accompanying drawings, and in which:

FIG. 1 is a block diagram of an illustrative architecture for allocating trades;

FIG. 2 is a flow chart of an illustrative process for allocating trades;

FIG. 3 is another block diagram of an illustrative architecture for allocating trades;

FIG. 4 is a flow chart of an illustrative process for allocating trades;

FIG. 5 is a flow chart of an illustrative process for allocating a block buy order;

FIG. 6 is a flow chart of an illustrative process for computing a total deviation from pro-rata;

FIG. 7 is a flow chart of an illustrative process for allocating the residual quantity to accounts with a pro-rata share above the minimum trade size;

FIG. 8 is a flow chart of an illustrative process for allocating a sell order;

FIG. 9 is a flow chart of an illustrative process for implementing a second sub-routine of the allocation process for a sell order;

FIG. 10 is a flow chart of an illustrative process for implementing a third sub-routine of the allocation process for a sell order;

FIG. 11 is a flow chart of an illustrative process for implementing a fourth sub-routine of the allocation process for a sell order;

FIG. 12 is a flow chart of an illustrative process for implementing a fifth sub-routine of the allocation process for a sell order;

FIG. 13 is a flow chart of an illustrative process for implementing a sixth sub-routine of the allocation process for a sell order;

FIG. 14 is a flow chart of an illustrative process for implementing a seventh sub-routine of the allocation process for a sell order;

FIG. 15 is a flow chart of an illustrative process for implementing an eighth sub-routine of the allocation process for a sell order;

FIG. 16 is a flow chart of an illustrative process for implementing a ninth sub-routine of the allocation process for a sell order;

FIG. 17 is a flow chart of an illustrative process for implementing a tenth sub-routine of the allocation process for a sell order;

FIG. 18 is a flow chart of an illustrative process for implementing an eleventh sub-routine of the allocation process for a sell order;

FIG. 19 is a table related to an illustrative process for allocating a block buy order;

FIG. 20 is a table related to an illustrative process for allocating a block sell order;

FIG. 21 is a flow chart of an illustrative process for allocating a MUNI New Issue order;

FIG. 22 is a table related to an illustrative process for allocating a MUNI New Issue order;

FIG. 23 is a flow chart of an illustrative process for implementing a data check of an allocation; and

FIG. 24 is a flow chart of an illustrative process for implementing a rounding algorithm.

### DETAILED DESCRIPTION

To provide an overall understanding of the systems, devices, and methods described herein, certain illustrative embodiments will be described. It will be understood that the systems, devices, and methods described herein may be adapted and modified for any suitable application and that such other additions or modifications will not depart from the scope hereof.

In the following discussion of illustrative embodiments, the terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “based on,” as used in the claims and specification herein, is not exclusive and allows for being based on additional factors that may or may not be described.

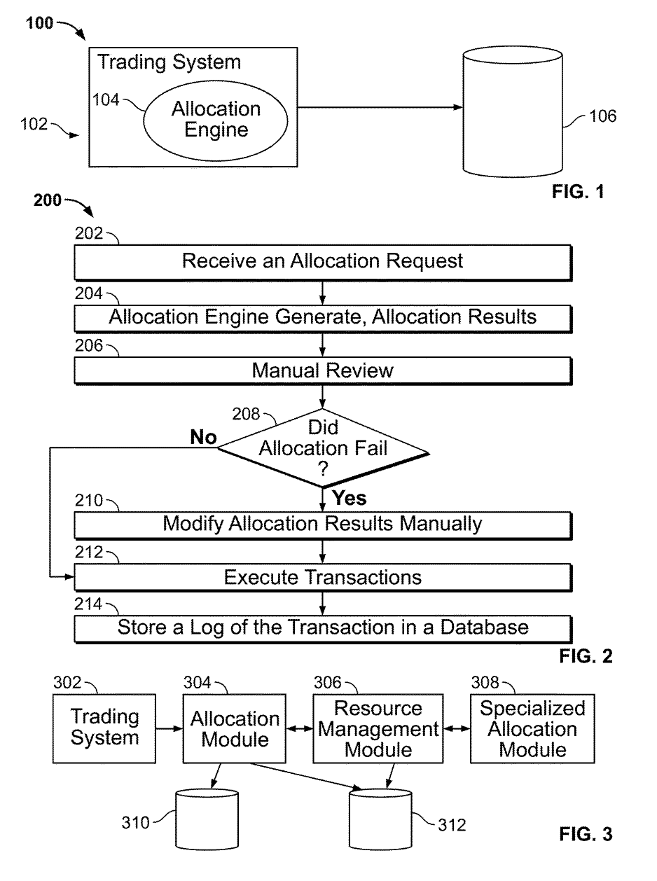

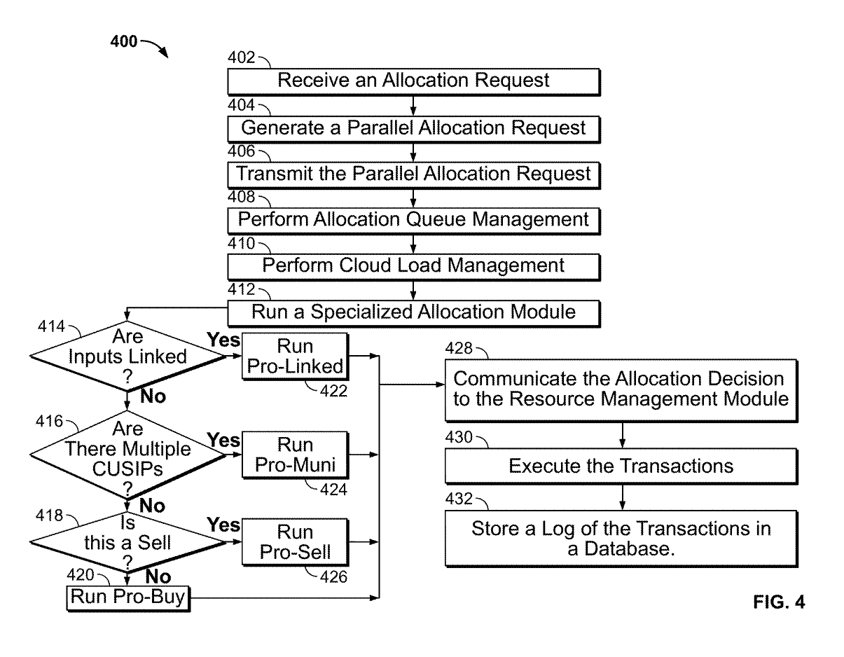

FIG. 1 is a block diagram of an illustrative architecture 100 for allocating trades. The illustrative architecture 100 includes a trading system 102, an allocation engine 104 and a database 106. The allocation engine 104 is an integral part of the trading system 102. The trading system 102 communicates with database 106. For example, the trading system 102 may be a typical trading system, such as order management systems by Charles River or order management systems Fidessa and Aladdin by Blackrock. However, determining allocation for aggregate orders may be computationally intensive and these integrated solvers may take on the order of multiple seconds and minutes to reach an allocation decision. For example, 30 seconds may be too long to allocate a trade in an industry where time is of the essence, and trades are expected to happen on the order of a few seconds, or fractions of seconds. Most traditional Global Trading Systems use an architecture such as illustrative architecture 100, which prioritizes speed over power. For example, the illustrative architecture 100 may be used to carry out the processes described in FIGS. 4-18 with respect to allocation of buy orders and allocation of sell orders.

FIG. 2 is a flow chart of an illustrative process 200 for allocating trades. The illustrative process 200 may be carried out by a trading system (e.g., trading system 102 of illustrative architecture 100 in FIG. 1). At step 202, the trading system receives an allocation request. For example, three accounts have placed orders for a trade in financial instrument A. At step 204, the allocation engine (e.g., allocation engine 104 of illustrative architecture 100 in FIG. 1) generates allocation results. For example, the allocation engine may automatically determine pro-rata allocations for the three accounts having placed orders for financial instrument A, subject to a minimum trade size set by the issuer of A. At step 206, a manual review takes place. For example, a manual review may be part of the standard process. Alternatively, a manual review may be triggered only in certain instances. For example, the manual review may be triggered by an inability to allocate the trade pro-rata between the three accounts, subject to the minimum trade size requirement. In some examples, high minimum lot size requirements, which issuers may impose, may result in a failed allocation. In other examples, minimum trade increment requirements may also result in a failed allocation.

At step 208, a determination may be made either manually or automatically of whether the allocation failed. At step 210, when it is determined that the allocation failed, a manual modification of the allocation results may take place prior to step 212. For example, a determination may be made (manually or automatically) than one of the accounts cannot be allocated, and instead shares should be re-distributed pro-rata between the remaining two accounts. In this example, all of the pro-rata shares previously corresponding to the third account may be manually re-allocated between the two accounts which met the minimum size requirement. This manually corrected pro-rata allocation deviates from pro-rata, and as a result may disadvantage the third account. In some examples, corrected pro-rata allocations may deviate for multiple accounts substantially from an initial pro-rata allocation and from an advantageous pro-rata allocation. As used herein, an advantageous pro-rata allocation refers to an allocation which is closest to the initial pro-rata determination, e.g., based solely on order size, while still taking into account additional constraints. In some examples, manual allocation may introduce subjectivity and may potentially disadvantage smaller accounts. Furthermore, manual allocations may also increase a risk of human error in allocations. Alternatively, automatic allocations which rely on an initial pro-rata allocation and truncate accounts falling below a minimum trade size amount may also not be advantageous, and may in fact be biased against smaller accounts which have a lower probability of getting their orders filled, and in particular a lower probability of getting their orders filled earlier in the life of the trade.

Alternatively, based on a determination at step 208 that the allocation did not fail, the trading system may proceed to execute the transaction or trade according to the allocation results generated by the allocation engine at step 204. At step 214, the trading system may store a log of the trade or transaction in a database (e.g., database 106 of illustrative architecture 100 in FIG. 1). For example, the log stored in the database may include the initial allocation results generated by the allocation engine, and the manual modifications implemented at step 210. Logs of trades and transactions may provide records for regulatory examinations, and create a necessary audit trail.

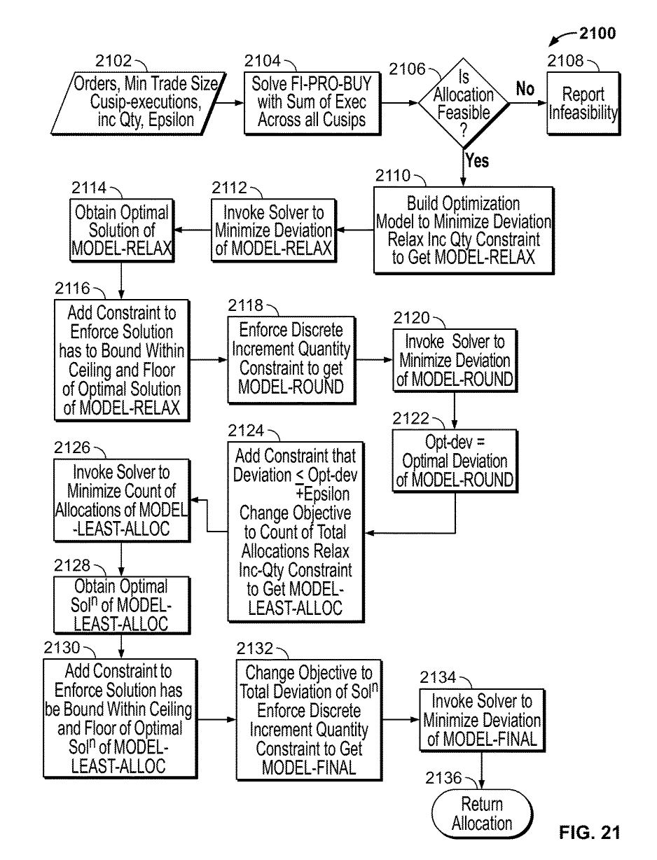

FIG. 3 is another block diagram of an illustrative architecture 300 for allocating trades. The illustrative architecture 300 includes a trading system 302, an allocation module 304, a resource management module 306, a specialized allocation module 308, a first database 310 and a second database 312. Illustrative architecture 300 may be better suited than the illustrative architecture 100 of FIG. 1 to reach an allocation decision by separating the allocation service from the trading system, and building the allocation service outside of the trading system. Illustrative architecture 300 also includes a robust queuing system which may handle multiple allocation requests for multiple trades either sequentially or in parallel. In an illustrative embodiment, the trading system 302 communicates information regarding a trade to the allocation module 304. The allocation module 304 in turn communicates an allocation request to the resource management module 306. At least one advantage of the illustrative architecture system 300 is the ability to prioritize power over speed, which may be helpful when solving large optimization problems. At least another advantage of the illustrative architecture system 300 is the ability to terminate an allocation sub-routine (e.g., a routine taking too long, or a routine having used up all of the available memory) without terminating the general execution-allocation process. For example, the illustrative architecture 300 may be helpful to run the MUNI new issue routine described below in relation to FIG. 21.

The resource management module 306 determines an amount and distribution of resources to compute the allocation request, and communicates the allocation request and the determined resource distribution to the specialized allocation module 308. For example, a cloud based service such as Amazon Web Services may be used to build the allocation service, and CPUs may be farmed on demand when required. The specialized allocation module 308 determines one of multiple algorithms best suited for the trade, and runs the selected algorithm to determine an optimum allocation. The specialized allocation module 308 communicates the optimum allocation to the resource management module 306. In an illustrative embodiment the resource management module 306 and specialized allocation module 308 may communicate with one another until an optimum allocation and optimum resource distribution are achieved. The resource management module 306 may communicate with the second database 312 and store data associated with resource distribution. The resource management module 306 communicates the optimum allocation and optimum resource distribution to the allocation module 304. The allocation module 304 may store information related to the trade in the first database 310. For example, optimization logs may be stored in flat (text) files instead of tabular forms. These flat files may more easily preserve the record and data necessary for regulatory examinations and audits, by storing non-tabular data in addition to tabular data. Alternatively, the resource management module 306 may communicate the optimum allocation and optimum resource distribution directly to the trading system for execution. For example, the resource management module 306 may apply logic to determine computational intensity of an allocation request, i.e., whether the allocation request is relatively straight forward or complex in its calculation or handling needs. The allocation requests may be labeled or categorized by the resource management module 306 based on the determination and placed in different queues for handling so that simple requests may be handled in a separate queue from complex requests. Handling of the queues may be optimized so that the appropriate service and resources are assigned a suitable request.

FIG. 4 is a flow chart of an illustrative process 400 for allocating trades. The illustrative process 400 may be carried out by a trading architecture (e.g., trading architecture 100 for allocating trades in FIG. 1 or trading architecture 300 for allocating trades in FIG. 3). At step 402, the architecture or system receives an allocation request 402. Steps 404 through 412 are optional. In some embodiments, steps 404 through 412 may be used upon a determination that a trade is a linked-input trade, and/or upon a determination that the trading architecture requires resource optimization in view of the type or size of trades requested. In an exemplary embodiment, at step 404, the architecture or system generates a parallel allocation request. At step 406, the architecture or system transmits the parallel allocation request. At step 408, the architecture or system performs allocation queue management. The allocation queue management at step 408 may include determining information about the allocation request to identify computational complexity so that simple and complex requests can be handled in dedicated queues. In some scenarios, a queue manager may be used to monitor handling of the queues and avoid duplicative handling of the queues. At step 410 the architecture or system performs cloud load management. In one example, request queues can be assigned to suitable handlers so that the load across the cloud system components is relatively stable. At step 412, the architecture or system runs a specialized allocation module (e.g., specialized allocation module 308 from FIG. 3). At step 414, the architecture or system determines whether the trade is a linked-input trade. When it is determined that the trade is a linked-input trade, the process moves to step 422, in which a specialized algorithm for allocating linked-input trades is selected and run. When the system determines that the trade is not a linked-input trade at step 414, at step 416, the system determines whether there are multiple CUSIPs involved in the trade, indicating a MUNI New issue trade. When it is determined that the trade is MUNI New issue trade, the process moves to step 424, in which a specialized algorithm for allocating MUNI New issue orders is selected and run. When the system determines that the trade is not a MUNI New issue at step 416, the system determines whether the trade is a sell order. When it is determined that the trade is a sell order, the process moves to step 426, in which a specialized algorithm for allocating sell orders is selected and run. When the system determines that the trade is not a sell order at step 418, process moves to step 420, in which a specialized algorithm for allocating buy orders is selected and run. After any of steps 422, 424, 426 or 420, at step 428 the system communicates the allocation results obtained from running the specialized algorithm associated with the identified trade to a resource management module. At step 430 the system executes the trade according to the allocation results obtained from the running of the specialized algorithm, using the resources assigned by the resource management module (e.g., resource management module 306 in FIG. 3). At step 432, the system stores a log of the trade in a database (e.g., database 310 or 312 in FIG. 3). For example, the system may store a log of the type of trade, the allocation results, the resources used, the number of executions, the fill rate, and the deviation from pro-rata for each account and each execution.

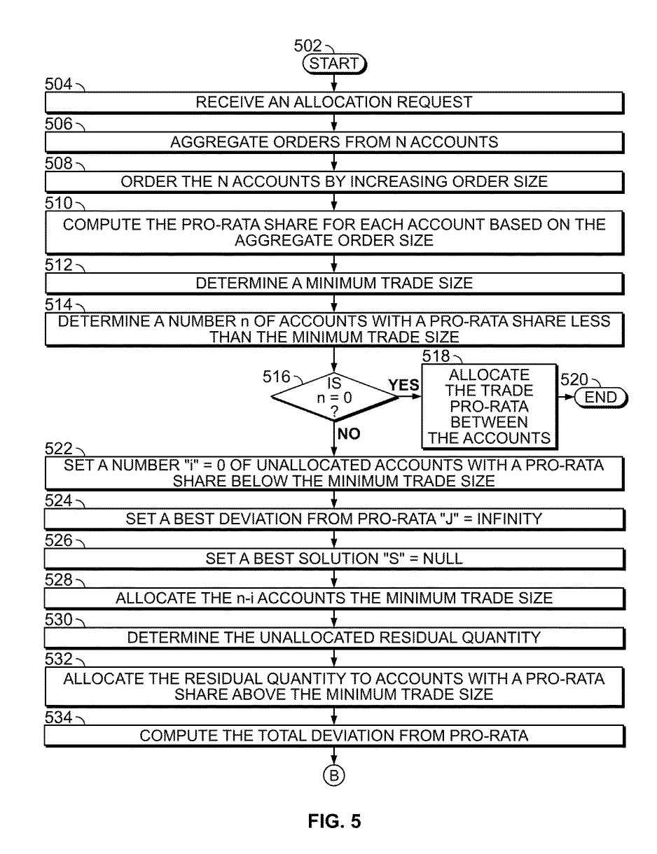

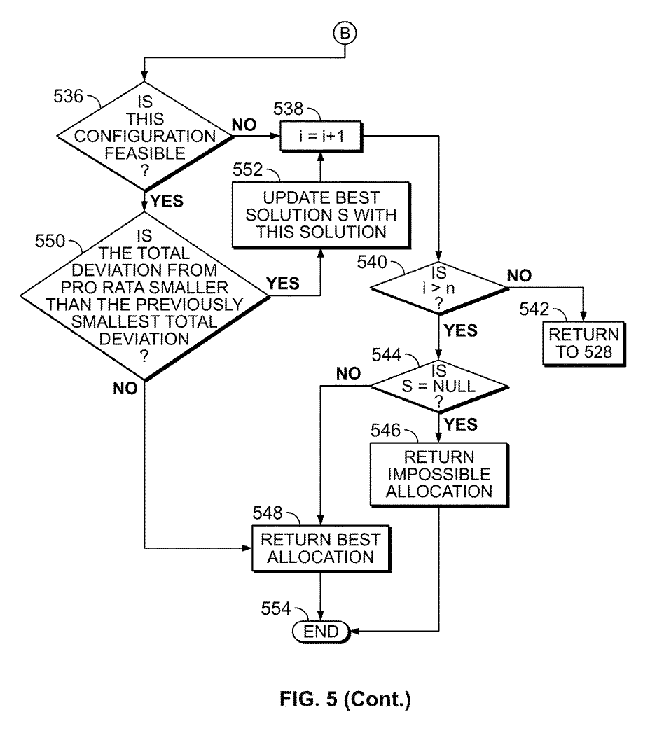

At least one advantage of the illustrative allocation process 400 of FIG. 4 is the ability to make a preliminary allocation first and to execute second. This was previously simply impossible—all trades were executed first, and allocated second. By providing a much quicker allocation process, on the order of seconds or fractions of seconds, as opposed to minutes, a preliminary allocation can now be done “on the fly” prior to executing a trade. The preliminary allocation is predictive, prior to the trade being executed, of the actual allocation to be completed after the trade is executed. In some embodiments, the preliminary allocation is identical to the actual allocation after execution. In other embodiments, data concerning the accounts participating in the trade may change between the preliminary allocation and the actual allocation, such that the actual allocation differs from the preliminary allocation. A much quicker allocation can be obtained by identifying different scenarios at the aggregate order level (buy, sell, Muni new issue, linked orders), and by identifying different sub-scenarios (for example the four types of orders which may exist within a buy aggregate order). This much quicker allocation process enables the preliminary allocation, which is performed prior to execution. The particular sub-routines described in FIGS. 5-18 implement a new process for identifying and categorizing certain types of orders, such that allocation can take place in fractions of seconds, and as noted above, a predictive preliminary allocation can take place prior to execution. Allocating first minimizes the risk of executed trades simply not being able to be allocated, or additional trades having to be completed at an additional transaction cost for financial management companies. Another related advantage of the illustrative allocation process 400 of FIG. 4 is the ability to hedge earlier on, and/or more quickly. Hedging cannot accurately take place until a trade has been allocated, to minimize risk. For example, a particular account may be focused on exposure to a particular interest rate, achievable only through exposure to multiple currencies, and financial instruments can be bought or sold to hedge away from unwanted currency exposures.

At least one advantage of the illustrative allocation process 400 of FIG. 4 is also to provide more advantageous and equitable trade allocations among client accounts over time. Client accounts with order amounts falling “below the [minimum trade size] line” have a much greater chance of getting an allocation, and getting an advantageous allocation. For example, as the fill rate increases during the execution of a trade order, the allocation distribution among accounts gets closer to pro-rata (i.e., an overall deviation from pro-rata is reduced). This reduction of the deviation from pro-rata is present not only across a single trade but also when results are aggregated across multiple trades. Such trade allocation will contribute to more consistent investment results across client accounts, increasing allocation fairness. In a simulation of the illustrative allocation process 400 of FIG. 4, with at least one account with a pro-rata share below the minimum trade size, illustrative process 400 resulted in 86.4% of accounts being allocated with an overall deviation from pro-rata of 1.6%, in contrast with only 80.8% of accounts allocated and a 4.7% deviation from pro-rata achieved by using a process such as illustrative process 200 of FIG. 2. At least another advantage of this exemplary embodiment of FIG. 4 is the ability to find the most advantageous allocation (i.e., the allocation resulting in the minimum deviation from pro-rata allocation) for aggregated bond trades, while at the same time automatically allocating the trade to a maximum number of client accounts of all sizes, and minimizing the need for manual intervention.

FIG. 5 is a flow chart of an illustrative process 500 for allocating a block buy order. The illustrative process 500 may be carried out by a trading architecture (e.g., trading architecture 100 for allocating trades in FIG. 1 or trading architecture 300 for allocating trades in FIG. 3). For example, illustrative process 500 may be the process selected to be run at step 420 of FIG. 4 and implemented as a computer algorithm. At step 502, the process starts. At step 504, an allocation request is received. In some embodiments, the allocation request may take place before or after execution. At step 506, orders in a financial instrument are aggregated from N accounts. For example, N accounts have expressed interest in buying the financial instrument being traded by placing orders (placed orders) with fixed amounts. At step 508, the N accounts are ordered by increasing order size. At step 510, the process calculates a pro-rata share for each account, where by definition the pro-rata share is based on the aggregate order size, and the respective size of the placed orders placed by each of the N accounts. At step 512, the process determines a minimum trade size. For example, a minimum trade size may be set by different parties. At step 514, the process determines a number n of accounts, less than or equal to the number N of accounts, which have a pro-rata share below a minimum trade size.

For example, as noted earlier in an example with respect to FIG. 2, with strict pro-rata allocations, the n accounts falling below the minimum trade size would not have been allocated—with the strict pro-rata allocation all accounts with pro-rata shares below the minimum trade size are effectively truncated, and the process re-allocates all of the truncated shares to accounts with orders above the minimum trade size. Strict pro-rata allocation tends to be less advantageous for smaller client accounts, which may generally place smaller orders, and may be systematically disadvantaged over time because it is harder to fill smaller individual orders given the minimum trade and increment sizes imposed by sellers and/or issuers.

With respect to the exemplary embodiment of FIG. 5, at step 514, the process 500 requires an initial determination of a number n of accounts, less than or equal to the number of N accounts, with the n accounts having a pro-rata share below a minimum trade size. For example, the number n of accounts may be 0. Alternatively, the number n of accounts may be greater than 0. At step 516, the process determines whether n is 0. Based on a determination that n is equal to 0 at step 516, at step 518 the process applies the pro-rata allocation between the N accounts, and the process ends at step 520. Alternatively, based on a determination that n is not equal to 0, the process proceeds to step 522. At step 522, the process sets a number “i”=0 of the n accounts with a pro-rata share below the minimum trade size. Proceeding to step 524, the process sets a best deviation pro-rata “J”=infinity. Proceeding to step 526, the process sets a best allocation solution “S”=null. At step 528, the process proceeds to allocate the n−i accounts (the number of accounts with a pro-rata share below the minimum trade size which are getting an allocation) with the minimum trade size. Proceeding to step 530, the process next determines the unallocated residual quantity from the aggregate order after allocating the n−i accounts. At step 532, the process next allocates the residual quantity to the accounts with a pro-rata share above the minimum trade size (i.e. the N−n accounts). At step 534, the process computes the total deviation from pro-rata. For example, the process computes for each account a deviation between the allocated amount and the pro-rata allocation amount, and sums all of the deviations. At step 536, the process determines whether the obtained allocation configuration (based on not allocating i accounts with a pro-rata share below the minimum trade size) is feasible. In the event that the configuration is not feasible (for example, because no allocation is possible given the constraints), the process proceeds to step 538, where the number i of the n accounts with a pro-rata share below the minimum trade size is incremented by one. At step 540, in the event that i is not greater than n, the process proceeds to step 542, which returns to step 528 and proceeds with allocation. In the event that at step 540 i is in fact greater than n, the process proceeds to step 544 where a determination is made of whether the best solution S is still “Null”, and if this is the case, the process proceeds to step 546, returning an impossible allocation, and ending at step 554. If at step 544 the solution S is not null, then the process returns the best allocation at step 548. Returning to step 536, if the configuration identified is feasible, then the process proceeds to step 540, where it is determined whether the total deviation from pro-rata is smaller than the previously smallest total deviation from pro-rata. If this is the case, then the process proceeds to update the solution S with the current solution at step 552. If the total deviation from pro-rata is not smaller than the previously smallest total deviation from pro-rata, the process proceeds to step 548, where it returns the best available allocation and ends at step 554.

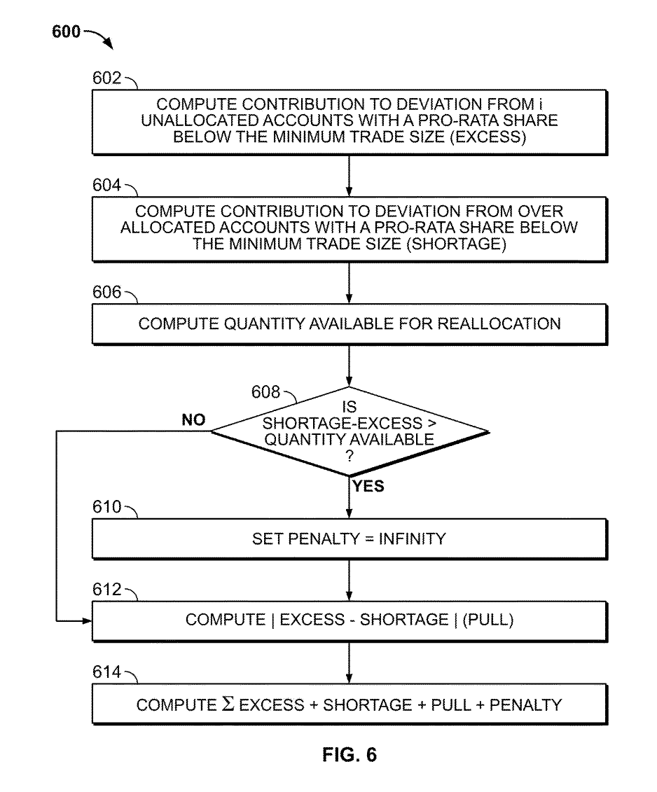

FIG. 6 is a flow chart of an illustrative process 600 for computing a total deviation from the pro-rata allocation, taking place for example at step 534 of the illustrative process 500 of FIG. 5. The illustrative process 600 may be carried out by a trading architecture (e.g., trading architecture 100 for allocating trades in FIG. 1 or trading architecture 300 for allocating trades in FIG. 3). At step 602, the process 600 computes a contribution to the deviation from the i unallocated accounts with a pro-rata share below the minimum trade size (referred to as “Excess”). Excess is a contribution to a deviation from pro-rata allocation from the “i” unallocated accounts with a pro-rata share below the minimum trade size. This Excessᵢ=Σⱼ₌₀ⁱdⱼT is the quantity freed up by not allocating to the first i of n_{b} accounts. This Excess represents the contribution to the deviation from pro-rata from accounts left un-allocated below the minimum trade size line. At step 604, the process computes a contribution to the deviation from the over-allocated accounts with a pro-rata share below the minimum trade size (referred to as “Shortage”). Shortage is a contribution to the deviation from pro-rata allocation from a number of accounts with a pro-rata share below the minimum trade size which are over-allocated relative to pro-rata. This Shortageᵢ=Σⱼ₌ᵢ₊₁ⁿ^{_{b}}(M−dⱼT) is the quantity shortage due to minimum allocation to remaining accounts below the minimum allocation line. This shortage represents the contribution to the deviation from pro-rata from accounts over-allocated below the minimum trade size line.

At step 606, the process computes a quantity available for reallocation. This total quantity available for re-allocation (or spare quantity) is the amount of shares present within a number of accounts (m-n) which have a pro-rata share above the minimum trade size, defined as: qtyₛₚₐᵣₑ=Σⱼ₌ₙ_{_{b}}₊₁ⁿ(dⱼT−M), where n_{b} is the number of accounts below the minimum allocation line, dⱼ is the standard pro-rata allocation percentage for client j, T is the total executed size, and M is the allocation size. The implemented algorithm may assume that all client accounts are ordered increasingly by their pro-rata quantity, i.e., o₁≦o₂≦ . . . ≦oₙ. At step 608, the process determines whether the difference between Shortage and Excess (Shortage-Excess) is greater than the quantity available for allocation. If it is, the process proceeds to step 610 and sets a penalty=infinity, to signal that this allocation is unfeasible before proceeding to step 612. This Penalty is incurred when the Shortage minus the Excess is greater than an available quantity which is a quantity available for re-allocation from accounts with a pro-rata share above the minimum trade size. This

$${Penalty}_{i} = \{ \begin{matrix}T & if {Shortage}_{i} - {Excess}_{i} > {qty}_{spare} \\ 0 & otherwise\end{matrix}$$

ensures that only a maximum of spare quantity can be pulled from accounts above minimum allocation line. Alternatively if at step 608, the shortage-excess is less than the quantity available, then the process proceeds to step 612 directly where it computed the absolute value of the difference between excess and shortage (referred to as “Pull”). This Pullᵢ=|Excessᵢ−Shortageᵢ| is the quantity required to bring (or send) from the accounts above the line to satisfy allocations to accounts below the line. This Pull represents the contribution to deviation from accounts above the line to satisfy the accounts below the line. The process then proceeds to step 614, where it computes the sum of the Excess, Shortage, Pull and Penalty.

At least one advantage of the process 600 of FIG. 6 is that minimizing the sum of the “Excess” “Shortage” “Pull” and “Penalty” amounts effectively minimizes any unnecessary transfers of tradeable lots from accounts located below the minimum trade size line to accounts located above the minimum trade size line, and vice versa. In an exemplary embodiment, the optimum solution is to not allocate to the first i of n accounts with a pro-rata share below the minimum trade size that minimizes the sum of the Excess, Shortage, Pull and Penalty.

At least another advantage of the process 600 of FIG. 6 as described above, is the ability to identify key metrics which are reliable indicators of an extent to which tradeable lots may need to be reallocated between various accounts, and a reduction in the time needed to allocate a trade. This translates into an ability to provide client accounts with the best chance of consistently receiving the most advantageous, equitable, efficient and mathematically accurate allocation within the universe of possible solutions.

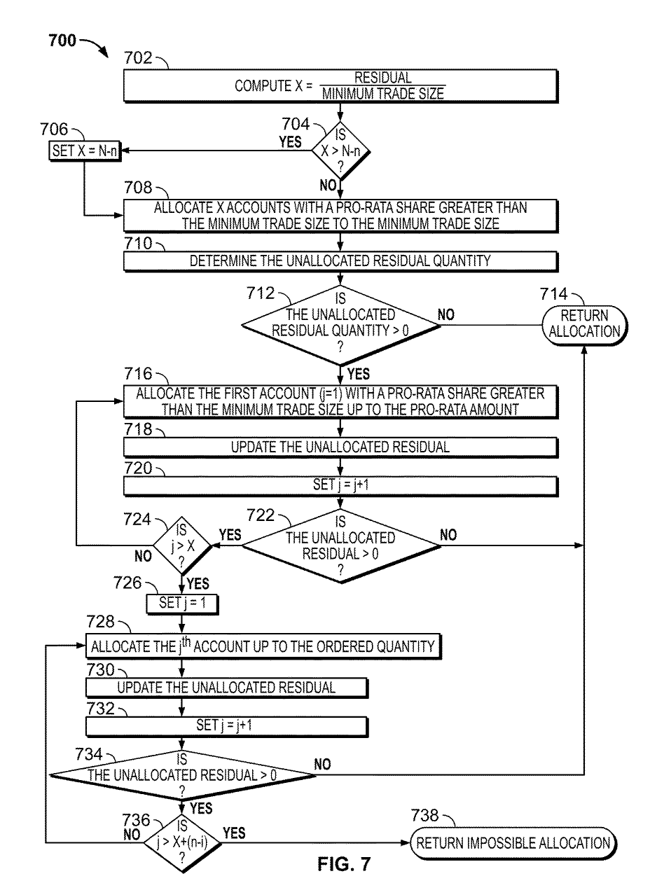

FIG. 7 is a flow chart of an illustrative process 700 for allocating the residual quantity to accounts with a pro-rata share above the minimum trade size, for example taking place at step 532 of the illustrative process 500 of FIG. 5. The illustrative process 700 may be carried out by a trading architecture (e.g., trading architecture 100 for allocating trades in FIG. 1 or trading architecture 300 for allocating trades in FIG. 3). At step 702, the process begins by computing an amount X which is equal to a ratio of the residual over the minimum trade size. At step 704, the process determines whether this amount X is greater than the number of accounts with a pro-rata share greater than the minimum trade size: N−n accounts. If at step 704 the process determines that X is greater than N−n, it proceeds to step 706 where it sets X equal to N−n. Otherwise, the process proceeds directly from step 704 to step 708, where for X accounts with a pro-rata share greater than the minimum trade size, the process allocates the minimum trade size. At step 710, the process determines the unallocated residual quantity, and at step 712, the process determines whether the unallocated quantity is greater than 0. In the event that the unallocated quantity is not greater than 0 the process proceeds to step 714 and returns the allocation. Alternatively, in the event that the unallocated residual quantity is greater than 0, the process proceeds to step 716, where it allocates the first account (j=1) with a pro-rata share greater than the minimum trade size, with an amount up to or equal to the pro-rata amount. At step 718, the process proceeds to update the unallocated residual, and step 720, the process proceeds to increment the value of the counter (j=j+1) before proceeding step 722. At step 722, the process determines whether the unallocated residual is again greater than 0. In the event that the unallocated residual quantity is not greater than 0, the process returns to step 714 and returns the allocation. Alternatively, in the event that the unallocated residual is greater than 0, the process proceeds to step 724. At step 724, the process determines whether the counter j has reached the number X. If at step 724 it is determined that j is greater than X, then the process proceeds to step 726 where j is set to 1. Otherwise, the process returns to step 716. Once j=1 at step 726, the process proceeds to step 728 where it allocates the j'th account up to the quantity ordered by that account. At step 730, the process updates the unallocated residual, and at step 723 updates the counter j such that j=j+1. At step 734, the process again determines whether the unallocated residual is greater than 0. If the unallocated residual quantity is not greater than 0, the process returns to step 714 where it returns the allocation. Alternatively if the unallocated residual is greater than 0, the process proceeds to step 736, where it determines whether j is greater than X+(n−i), in which case it proceeds to step 738 and returns an impossible allocation. Alternatively, if at step 736 the process determines that j is smaller than X+(n−i), the process returns to step 728 and continues the allocation process.

At least one advantage of the illustrative process 700 in FIG. 7 is the ability to not only determine how many accounts can be allocated, but the ability to also determine how much to allocate to each account, and by how much to over-allocate or under-allocate, to obtain the least deviation from pro-rata overall. In an exemplary embodiment, the advantage for each individual account is improved with this method over the course of multiple allocation cycles.

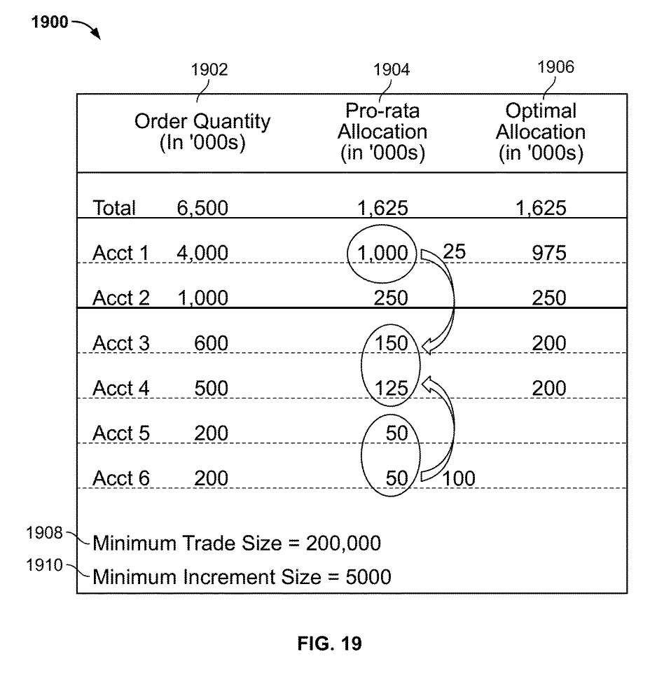

FIG. 19 is a table describing an illustrative process for allocating a block buy order. For example the table in FIG. 19 describes an illustrative process 1900 similar to illustrative process 500. An order quantity 1902 is indicated for each client account (Accounts 1-6). A pro-rata allocation quantity 1904 is also indicated for each client account. In the example shown in FIG. 19, a minimum trade size 1908 may be 200,000, and a minimum increment size 1910 may be 5,000.

As an initial example, if there are three client accounts with order quantities (in '000s) as follows: (Account 1, 1,000), (Account 2, 800), (Account 3, 200), the pro-rata allocation of each account would be 50%, 40% and 10%, respectively. These pro-rata percentages would correspond to 400, 320 and 80 ('000s) in execution, such that under a strict pro-rata allocation subject to the trading constraints, Account 3 with the 80 ('000s) pro-rata execution could not be completed, and the pro-rata share of Account 3 would be reallocated between accounts 1 and 2. When allocating 800 ('000s) shares out of the total 2,000 ('000s) shares from the aggregate order, there are 126 possible ways to allocate the trade that satisfy the constraints, for example (800, 0, 0), or (400, 200, 200), or (600, 0, 200), or (500, 300, 0), etc. Similarly, when allocating 1200 (in '000s) shares during another round of allocation, there may be 243 possible ways to allocate the remaining shares to satisfy the constraints.

As an additional example, in relation to Tables 1 and 2 below, with respect to the buy example shown in Table 1, the absolute deviation from pro-rata is smaller in the case of Scenario 1 (no allocation to Account 3) than in Scenario 2.

TABLE 1

| | | Execution Size: | 800,000 | | | |
|---|---|---|---|---|---|---|
| | | Block Size: | 2,000,000 | | | |
| | | Min Size: | 200,000 | | | |
| | | Pro-rata | | | Deviation | |
| | Total Qty | Allocation (in | Allocation | | from pro-rata | |
| Acct # | (in 000's) | 000's) | Scenario 1 | Scenario 2 | Scenario 1 | Scenario 2 |
| 1 | 1,000 | 400 | 445 | 335 | 45 | 65 |
| 2 | 800 | 320 | 355 | 265 | 35 | 55 |
| 3 | 200 | 80 | | 200 | 80 | 120 |

| | | |
|---|---|---|
| Total absolute deviation | 160 | 240 |

TABLE 2

| | | Execution Size: | 1,200,000 | | | |
|---|---|---|---|---|---|---|
| | | Block Size: | 2,000,000 | | | |
| | | Min Size: | 200,000 | | | |
| | | Pro-rata | | | Deviation | |
| | Total Qty | Allocation (in | Allocation | | from pro-rata | |
| Acct # | (in 000's) | 000's) | Scenario 1 | Scenario 2 | Scenario 1 | Scenario 2 |
| 1 | 1,000 | 600 | 660 | 560 | 60 | 40 |
| 2 | 800 | 480 | 540 | 440 | 60 | 40 |
| 3 | 200 | 120 | | 200 | 120 | 80 |

| | | |
|---|---|---|
| Total absolute deviation | 240 | 160 |

However, with respect to the buy example shown in Table 2, when the executed total amount is 1,200,000, Scenario 2 would be more advantageous because it results in a smaller deviation from pro-rata compared to Scenario 1.

Returning to the example shown in FIG. 19, following a pro-rata allocation, Accounts 1 and 2 are the only two of the six accounts which have pro-rata allocations which are greater than the minimum trade size 1908. Accordingly, following a strict pro-rata allocation, only account 1 and account 2 would receive an allocation, whereas accounts 3-6 would not be allocated. In this example, multiple rounds of successive allocations and executions may take place, with order quantities and pro-rata quantities being recomputed prior to each allocation and execution. In comparison to the strict pro-rata allocation 1904, an optimal allocation 1906 is shown, where the optimal allocation 1906 is for example the optimal allocation obtained by selecting and running a specialized algorithm at step 420 of illustrative process 400 of FIG. 4, further detailed as illustrative process 500 in FIG. 5. The amounts for the optimal allocation 1906 are obtained by not allocating to two accounts (Account 5 and Account 6), which would also not have been allocated using a strict pro-rata allocation. These smallest accounts below the minimum trade size (Accounts 5 and 6 in FIG. 6), may still not receive an allocation, but will have an increased chance of receiving the best possible allocation over multiple allocations and/or over time.

As shown in the exemplary embodiment of FIG. 19, instead of relying on strict pro-rata allocation and truncation, tradeable lots are created from the total pro-rata quantity available to accounts below the minimum trade size. For example, referring to illustrative process 500 described in FIG. 5, the number of n of accounts having a pro-rata share below the minimum account size is 4, whereas the determined number i of unallocated accounts with a pro-rata share below the minimum trade size is 2. With the optimal allocation 1906, the number of shares allocated pro-rata to accounts 3-6 are redistributed between accounts 1-4, such that four tradeable lots are created. Under the exemplary optimal allocation shown, four accounts are allocated instead of two with strict pro-rata allocation. As shown in FIG. 19, 100 shares are taken from accounts 5 and 6 and 25 shares are taken from account 1. As a result, the optimal allocation includes 975 shares for account 1 (instead of 1000 pro-rata) and 200 shares each for accounts 3 and 4 (instead of 150 and 125 pro-rata). Account 2 retains 250 shares (both pro-rata and optimal allocation). This optimal allocation minimizes the total deviation (summed up for each account) from the pro-rata allocation but maximizes the amount of accounts which receive an allocation. This optimal allocation also minimizes the total deviation from the pro-rata allocation (summed up for each account) over time, taking into account multiple allocation and execution cycles.

In an exemplary embodiment, as explained below with respect to FIG. 5, the results described in FIG. 19 may be preferably obtained through the implementation of the optimal algorithm of FIG. 5.

Use of the illustrative processes of FIGS. 4-18 and 21 is preferable to the use of optimizers. However, alternatively, the results described in FIG. 19 may also be obtained, albeit over a longer period of time, by building one or more optimization problems based on inputs from the trade order, as described below, and inputting this optimization problem into a solver which may run on an illustrative architecture such as illustrative architecture 300 of FIG. 3.

$$\begin{matrix}Minimize & c * x \\ s . t . & A * x \leq b \\ & 1 \geq x \geq 0\end{matrix}$$

$$c = [ {e}_{n} , {O}_{n} , {O}_{n} ]$$

$$A = [ \begin{matrix}- {I}_{n} & \frac{H}{T} {I}_{n} & {OO}_{n} \\ - {I}_{n} & - \frac{H}{T} {I}_{n} & {OO}_{n} \\ {OO}_{n} & - H * {I}_{n} & M * {I}_{n} \\ {OO}_{n} & H * {I}_{n} & - diag ( min ( T , {ord}_{n} ) ) \\ {O}_{n} & H * {e}_{n} & {O}_{n}\end{matrix} ]$$

$$b = [ {d}_{n} , - {d}_{n} , {O}_{n} , {O}_{n} , T ]$$

Last constraint is equality
eₙ is a 1-vector of n length
Oₙ is a 0-vector of n length
dₙ is standard pro-rata % vector of n length
Iₙ is unit diagonal matrix of dimension n
OOₙ is zero matrix of dimension n, n
ordₙ is open order quantity vector of n length
M is execution minimum and T is executed quantity
H is minimum increments

At least one advantage of the method described in FIG. 5, is the ability to obtain allocation results much more quickly than via the above optimizer method, and the ability to use an existing architecture such as illustrative architecture 100 in FIG. 1.

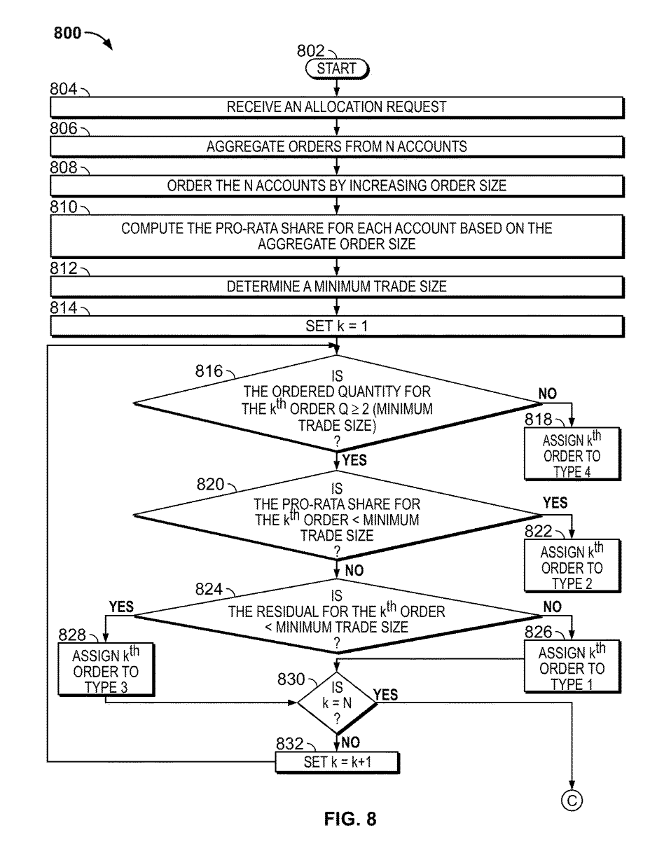

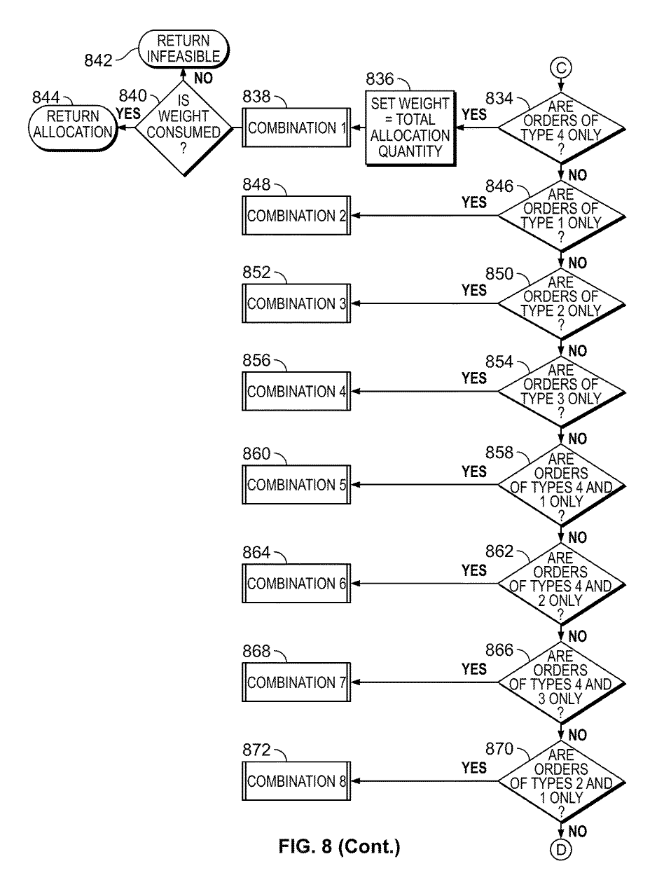

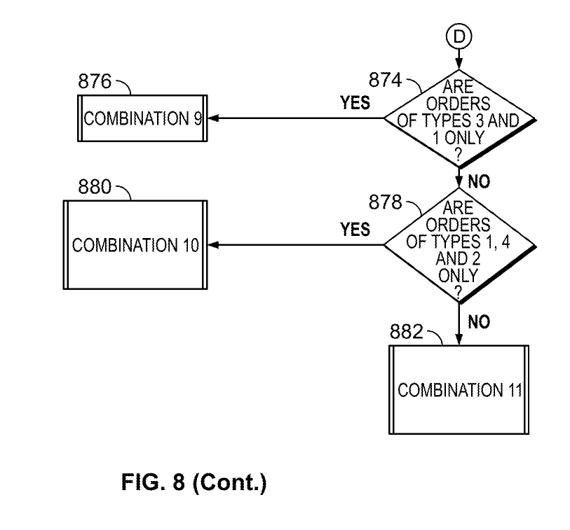

FIG. 8 is a flow chart of an illustrative process 800 for allocating a sell order. For example, illustrative process 800 may be the process selected to be run at step 426 of FIG. 4 and implemented as a computer algorithm. The illustrative process 800 may be carried out by a trading architecture (e.g., trading architecture 100 for allocating trades in FIG. 1 or trading architecture 300 for allocating trades in FIG. 3). Compared to a buy order, a sell order requires compliance with one additional constraint, a minimum residual quantity which can only be equal to 0 or at least equal to the minimum trade size. At step 802, the process starts. At step 804, orders in a financial instrument are aggregated from N accounts. For example, N accounts have expressed interest in selling a financial instrument being traded by placing orders with fixed amounts, resulting in placed orders. At step 806, the process aggregates the orders from the N accounts. At step 808, the process orders the N accounts by increasing order size. At step 810, the process calculates a pro-rata share for each account, where by definition the pro-rata share is based on the aggregate order size, and the respective size of the placed orders placed by each account. At step 812, the process determines a minimum trade size. At step 814, the process sets a counter k=1 before proceeding to step 816.

At step 816, the process determines whether the ordered quantity for the k'th order (Q) is greater than or equal to two times the minimum trade size. If at step 816 the ordered quantity Q is not greater than or equal to twice the minimum trade size, the process proceeds to step 818 and assigns the k'th order to “type 4,” described below. Alternatively, the process proceeds to step 820, where it determines whether the pro-rata share for the k'th order is strictly less than the minimum trade size. In the event that the pro-rata share for the k'th order is strictly less than the minimum trade size, the process assigns the k'th order to “type 2”, also described below. Alternatively, the process proceeds to step 824, where it determines whether the residual for the k'th order is strictly less than the minimum trade size. If at step 824 the residual for the k'th order is strictly less than the minimum trade size then the process proceeds to step 826, where it assigns the k'th order to “type 1”, also described below. Alternatively, the process proceeds to step 828 and assigns the k'th order to “type 3”, also described below, before proceeding to step 830, where the process determines whether the index k=N. If at step 830, the index k is equal to the number of accounts N, the process proceeds to step 834. Alternatively, the process proceeds to step 832 where index k is incremented, before returning to step 816.

At step 834, the process determines if the orders are of “type 4” only, in which case, the system proceeds to step 836, and sets a weight to be equal to the total allocation quantity, prior to running a combination 1 algorithm. At step 840, the process determines whether the weight is consumed, and if so returns an infeasible solution at step 842, or if the weight is not consumed, returns an allocation at step 844. For example, given a certain quantity (or weight) to allocate to the type 4 orders, the process determines the maximum total that can be allocated to the type 4 orders. In some embodiments, the desired weight can be varied between 0 and Q, and the allocation with the least deviation in the Q iterations can be identified and implemented. For example, if the type 4 orders consist of orders for 200, 200 and 350, and there is only 450 to allocate, a maximum of 400 can be allocated, split between the first two accounts. This is the so-called “knapsack” problem, which can be solved using a dynamic programming algorithm.

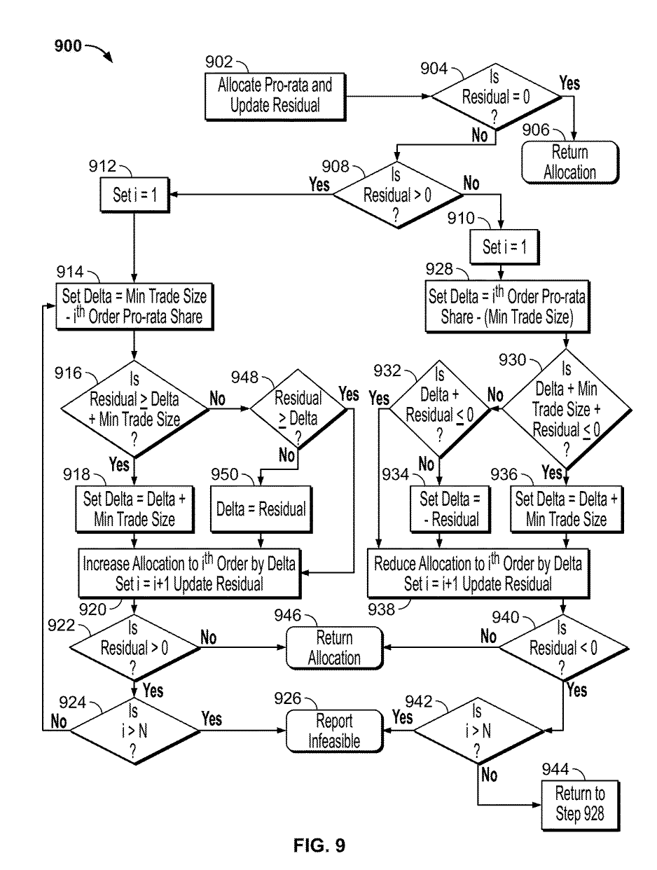

Alternatively at step 834, if the process determines that the orders are not of type 4 only, the process proceeds to step 846. Step 834 and 846 through 878 identify what types of orders are present in the aggregate order—there are only eleven possible types of order combinations. Once an order combination has been identified, the allocation problem may be solved in a way which is specific to that order combination, as implemented for example in the processes of FIGS. 9-18, which can be implemented as computer algorithms. The algorithm used at step 838 for Combination 1 may be an algorithm used to solve the so-called “knapsack” problem. The remaining algorithms used at steps 848, 852, 856, 860, 864, 868, 872, 876 and 880 are described in further detail with respect to FIGS. 9-18.

The four types of accounts indicated above as “type 1,” “type 2,” “type 3,” and “type 4” are defined based on order size and pro-rata quantity. First, type 1 orders obey all constraints on pro-rata (with pro-rata share greater than or equal to the minimum trade size, and the residual greater than or equal to the minimum quantity). Second, type 2 orders are at least twice the minimum trade size and obey the residual greater than the minimum trade size, but have a pro-rata share which is less than the minimum trade size and therefore fail one of the two constraints. Third, type 3 orders are at least twice the minimum trade size and obey the pro-rata quantity greater than or equal to the minimum trade size, but leave a residual which is not 0 and is less than the minimum trade size and therefore fail one of the two constraints. Finally, the type 4 orders are for a quantity less than or equal to twice the minimum trade size, which can only either be allocated fully or not at all. Type 2 and Type 3 orders are mutually exclusive. All other types of orders may happen simultaneously. For example, when the minimum trade size is 200, three orders may be as shown in Table 1 below.

TABLE 3

| Order | Pro-rata amount | Residual | Type of Order |
|---|---|---|---|
| 300 | 120 | 180 | 4 |
| 450 | 180 | 270 | 2 |
| 800 | 320 | 480 | 1 |

In another example, when the minimum trade size is 200, three orders may be as shown in Table 2 below.

TABLE 4

| Order | Pro-rata amount | Residual | Type of Order |
|---|---|---|---|
| 500 | 400 | 100 | 3 |
| 2000 | 1600 | 400 | 1 |
| 4000 | 3200 | 800 | 1 |

Accordingly, any allocation request for a sell order will be one of 11 combinations of these four types of orders:

TABLE 5

| | Type 4 | Type 2 | Type 3 | Type 1 |
|---|---|---|---|---|
| Combination 10 | x | x | | x |
| Combination 11 | x | | x | x |
| Combination 8 | | x | | x |
| Combination 9 | | | x | x |
| Combination 5 | x | | | x |
| Combination 7 | x | | x | |
| Combination 6 | x | x | | |
| Combination 2 | | | | x |
| Combination 3 | | x | | |
| Combination 4 | | | x | |
| Combination 1 | x | | | |

At least one advantage of the exemplary embodiment of FIG. 8 is the ability to obtain an allocation which is as close to a pro-rata allocation as possible, in a sell scenario, where there is an additional constraint of being unable to leave a non-tradeable loss. At least another advantage of the exemplary embodiment of FIG. 8 is the ability to subdivide the possible order combinations and to solve a solution which is specific to the type of orders encountered in the aggregate order.

FIG. 9 is a flow chart of an illustrative process for implementing a second sub-routine of the allocation process for a sell order. The illustrative process 900 may be carried out by a trading architecture (e.g., trading architecture 100 for allocating trades in FIG. 1 or trading architecture 300 for allocating trades in FIG. 3). In particular, the illustrative process of FIG. 9 is used to solve the allocation process for a sell order when orders are of type 1 only, i.e., orders which obey all constraints on pro-rata (with pro-rata share greater than or equal to the minimum trade size, and the residual greater than or equal to the minimum quantity). At step 902, the process allocates the aggregate order based on the pro-rata allocation, and updates the residual. At step 904, the process determines whether the residual is 0. If at step 904 it is determined that the residual is equal to 0, the process proceeds to step 906 and returns the allocation. Alternatively, the process proceeds to step 908 and determines whether the residual is strictly greater than 0. If the residual is greater than 0, the process proceeds to step 912 and sets an index i=1. The process then proceeds to step 914 and sets a delta equal to the difference between the minimum trade size and the i'th pro-rata share. The process proceeds to step 916 to determine whether the residual unallocated quantity is greater than or equal to the sum of the delta and the minimum trade size. If the Residual is greater than the delta plus the minimum trade size, the process proceeds to step 918 and sets the delta to be equal to the delta plus the minimum trade size, and proceeds to increase the allocation to the i'th order by the amount Delta, increments the index I, and updates the residual unallocated quantity at step 920. If at step 916 it is determined that the residual is not greater than or equal to the delta plus the minimum trade size, the process proceeds to determine at step 948 whether the residual is greater than or equal to the delta, and if not, at step 950 sets the delta to be equal to the residual. Alternatively, the process moves from step 948 directly to step 920. After step 920, if at step 922 it is determined that the residual is greater than 0, the process determines at step 924 whether i is greater than N, and if not, returns to step 914. If at step 924 i is greater than N, the process proceeds to step 926 and reports than an allocation is infeasible. Alternatively if at step 922 it is determined that the residual is not greater than 0, the process proceeds to step 946 and returns an allocation. Returning to step 908, if it is determined that the residual is not greater than 0, the process proceeds to step 910 and sets i=1. At step 928, the process sets the delta to be equal to the difference between the i'th order pro-rata share and the minimum trade size. At step 930, the process determines whether the sum of the delta, the minimum trade size, and the residual are all less than or equal to 0. If so, the process proceeds to step 936 and sets the delta to be equal to delta plus the minimum trade size. Alternatively, the process proceeds to step 932 and determines whether the sum of the delta and residual is less than or equal to 0. If so, the process proceeds to step 938 directly. Otherwise, the process proceeds to step 934 where the delta is set to be equal to minus the residual amount. At step 938, the process proceeds to reduce the allocation to the i'th order by delta, increments the index i, and updates the residual. At step 940, the process determines whether the residual is negative. In the event that the residual is negative, the process proceeds to step 942 and determines whether the index i is strictly greater than N. If not, at step 944, the process returns to step 928. If the index is greater than N, the process proceeds to step 926 and reports that allocation is infeasible. Alternatively, at step 940, in the event that the residual is negative, the process proceeds to step 946 and returns the allocation.

At least one advantage of the exemplary embodiment of FIG. 9 is the ability to identify that only type 1 orders are present in the aggregate order, and to more quickly and more efficiently solve for an allocation by taking into account the types of orders present in the aggregate. At least another advantage of the exemplary embodiment of FIG. 9 is the ability to obtain an allocation which is as close to a pro-rata allocation as possible, in a sell scenario, where there is an additional constraint of being unable to leave a non-tradeable loss.

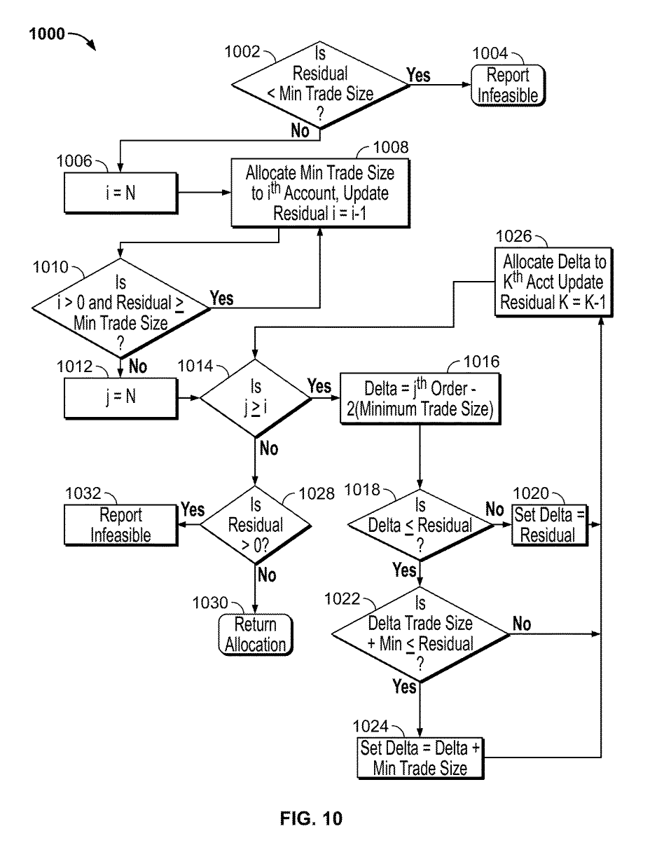

FIG. 10 is a flow chart of an illustrative process for implementing a third sub-routine of the allocation process for a sell order. The illustrative process 1000 may be carried out by a trading architecture (e.g., trading architecture 100 for allocating trades in FIG. 1 or trading architecture 300 for allocating trades in FIG. 3). In particular, the illustrative process of FIG. 10 is used to solve the allocation process for a sell order when orders are of type 2 only, i.e., orders which are at least twice the minimum trade size and obey the residual greater than the minimum trade size, but have a pro-rata share which is less than the minimum trade size and therefore fail one of the two constraints. At step 1002, the process determines whether the residual is less than the minimum trade size. If the residual is less than the minimum trade size, the process proceeds to step 1004, where it reports that allocation is unfeasible. Alternatively, the process proceeds to step 1006, where an index i is set to i=N (the number of accounts), and the process proceeds to step 1008 where the process allocates the minimum trade size to the i'th account, updates the residual and decrements the index i. The process then proceeds to step 1010 to determine whether the index i is strictly greater than 0 and the residual greater than or equal to the minimum trade size. In the event that these conditions are met, the process returns to step 1008. Alternatively, the process proceeds to step 1012, where it sets a second index j=N, and proceeds to determine at step 1014 whether the index j is greater than or equal to the index i. If this is not the case, the process proceeds to check at step 1028 where the residual is greater than 0, and if so reports allocation to be unfeasible at step 1032. Otherwise, the process proceeds to step 1030 to return the allocation. Returning to step 1014, if the index j is not greater than or equal to the index i, the process proceeds to step 1016, where it sets a quantity delta to be equal to the j'th order amount minus two times the minimum trade size, and proceeds to step 1018. At step 1018, the process determines whether delta is less than or equal to the residual. If not, the process proceeds to set delta to be equal to the residual at step 1020, and proceeds to step 1026. Alternatively, the process proceeds to step 1022, where it is determine whether the sum of the delta plus the minimum trade size is less than or equal to the residual. If this is not the case, the process proceeds to step 1026 and allocates the delta to the k'th account, updates the residual, and decrements k=k−1. Alternatively, the process proceeds to step 1024 and sets the delta equal to the sum of the delta plus the minimum trade size before proceeding to step 1026.

At least one advantage of the exemplary embodiment of FIG. 10 is the ability to identify that only type 2 orders are present in the aggregate order, and to more quickly and more efficiently solve for an allocation by taking into account the types of orders present in the aggregate. At least another advantage of the exemplary embodiment of FIG. 10 is the ability to obtain an allocation which is as close to a pro-rata allocation as possible, in a sell scenario, where there is an additional constraint of being unable to leave a non-tradeable loss.

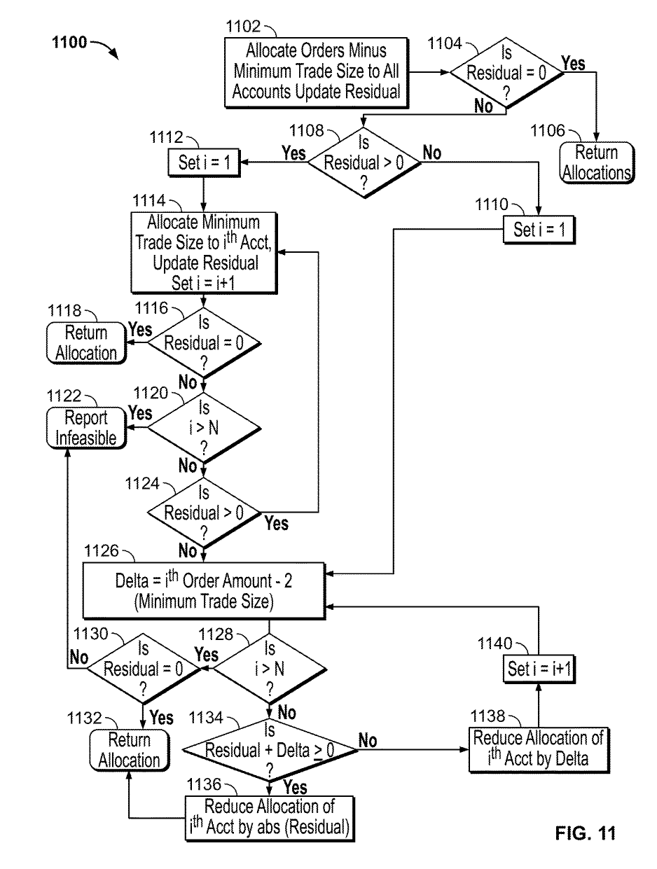

FIG. 11 is a flow chart of an illustrative process for implementing a fourth sub-routine of the allocation process for a sell order. The illustrative process 1100 may be carried out by a trading architecture (e.g., trading architecture 100 for allocating trades in FIG. 1 or trading architecture 300 for allocating trades in FIG. 3). In particular, the illustrative process of FIG. 11 is used to solve the allocation process for a sell order when orders are of type 3 only, i.e., orders which are at least twice the minimum trade size and obey the pro-rata quantity greater than or equal to the minimum trade size, but leave a residual which is not 0 and is less than the minimum trade size and therefore fail one of the two constraints. At step 1102, the process allocates orders minus the minimum trade size to all accounts, and updates the residual. At step 1104, the process determines whether the residual is equal to 0. If so, the process proceeds to step 1106 and returns the allocation. Otherwise, the process proceeds to step 1108 and determines whether the residual is strictly greater than 0. If it is not, the process sets index i=1 at step 1110 and proceeds straight to step 1126. If the residual is strictly greater than 0, the process proceeds to step 1112, where it sets index i=1, and proceeds to step 1114, where it allocates the minimum trade size to the i'th account, updates the residual, and increments index i. At step 1116, the process again determines if the residual is equal to 0, and if so proceeds to step 1118 where it runs the allocation. Otherwise, the process proceeds to step 1120, where it determines whether index i is strictly greater than N, and if so proceeds to step 112 where it reports an impossible allocation. Otherwise, if i is not strictly greater than N, the process proceeds to step 1124, where it determines whether the residual is greater than 0. If so, the process returns to step 1114. Otherwise, the process continues to step 1126, where it sets delta to be equal to the amount of the i'th order minus two times the minimum trade size). At step 1128, the process determines whether index i is strictly greater than N, and if so, determines at step 1130 whether the residual is equal to 0. If so, the process proceeds to step 1122 to report that allocation is unfeasible. Otherwise if at step 1130 the residual is not equal to 0, the process proceeds to step 1132 and returns the allocation. Alternatively, if at step 1128 the process determines that index is not strictly greater than N, the process proceeds to step 1134 and determines whether the sum of the residual and the delta is greater than or equal to 0. If so, the process, at step 1136, reduces the allocation of the i'th account by an amount equal to the absolute value of the residual, and returns the allocation results at step 1132. Otherwise, the process proceeds to step 1138, reduces the allocation of the i'th account by delta, and proceeds to step 1140 where it increments the index i before returning to step 1126.

At least one advantage of the exemplary embodiment of FIG. 11 is the ability to identify that only type 3 orders are present in the aggregate order, and to more quickly and more efficiently solve for an allocation by taking into account the types of orders present in the aggregate. At least another advantage of the exemplary embodiment of FIG. 11 is the ability to obtain an allocation which is as close to a pro-rata allocation as possible, in a sell scenario, where there is an additional constraint of being unable to leave a non-tradeable loss.

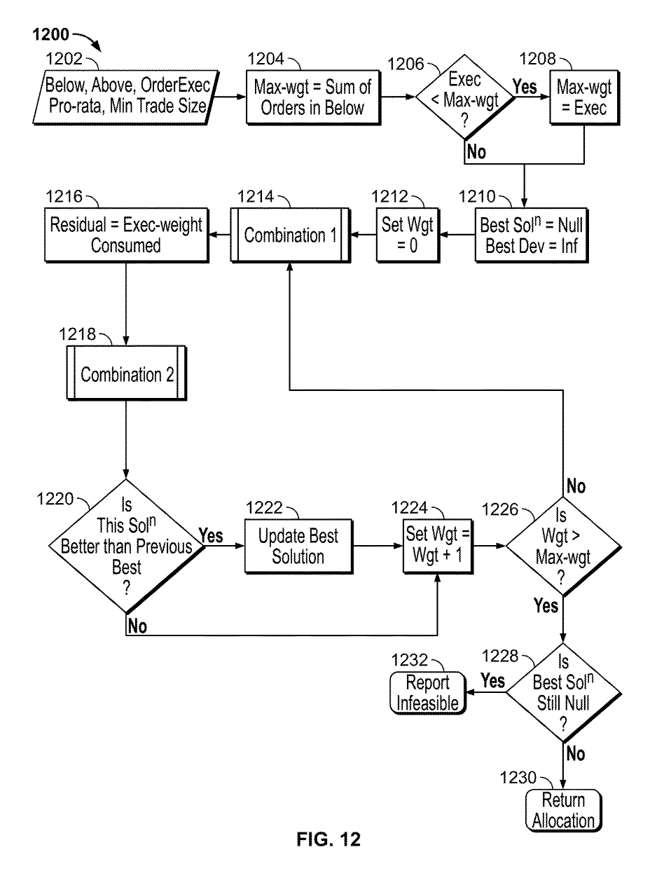

FIG. 12 is a flow chart of an illustrative process for implementing a fifth sub-routine of the allocation process for a sell order. The illustrative process 1200 may be carried out by a trading architecture (e.g., trading architecture 100 for allocating trades in FIG. 1 or trading architecture 300 for allocating trades in FIG. 3). In particular, the illustrative process 1200 of FIG. 12 is used to solve the allocation process for a sell order when orders are of type 4 and type 1 only, i.e., orders for a quantity less than or equal to twice the minimum trade size, which can only either be allocated fully or not at all, and orders which obey all constraints on pro-rata (with pro-rata share greater than or equal to the minimum trade size, and the residual greater than or equal to the minimum quantity). At step 1202, the process receives inputs with respect to the minimum trade size, the accounts below or above the minimum trade size, the executed or quantity intended for execution, and the pro-rata distribution. At step 1204, the process sets a maximum weight to be equal to the sum of the orders for accounts with a pro-rata distribution below the minimum trade size. At step 1206, the system determines whether the executed amount is strictly less than the maximum weight. If so, the process proceeds to step 1208 and sets the maximum weight to be equal to the executed amount or amount intended for execution. Otherwise, the process proceeds directly step 1210, where it sets the best solution to be equal to “Null” and the best deviation to be equal to “infinity,” before proceeding step 1212 where the weight is set to be equal to 0. At step 1214, the process may call the combination 1 routine (described above as the so-call “knapsack” routine) before proceeding to step 1216 and setting the residual as the executed quantity minus the weight consumed and proceeding to step 1218 where the “combination 2” process may be used, e.g., by running an algorithm such as the one described in relation to FIG. 9). At step 1220, the process determines whether the current solution is better than the previous best solution, and if this is the case updates the best solution at step 1222. Alternatively, the process proceeds directly to step 1224, where the weight is incremented by 1. At step 1226, the process determines whether the weight is strictly greater than the maximum weight, and if not, returns to step 1214. Alternatively, the process proceeds to step 1228 where it is determined whether the best solution is still null. If so, the process proceeds to step 1232, where it reports that allocation is unfeasible. Alternatively the process proceeds to step 1230 and returns the allocation.

At least one advantage of the exemplary embodiment of FIG. 12 is the ability to identify that only type 4 and type 1 orders are present in the aggregate order, and to more quickly and more efficiently solve for an allocation by taking into account the types of orders present in the aggregate. At least another advantage of the exemplary embodiment of FIG. 12 is the ability to obtain an allocation which is as close to a pro-rata allocation as possible, in a sell scenario, where there is an additional constraint of being unable to leave a non-tradeable loss.

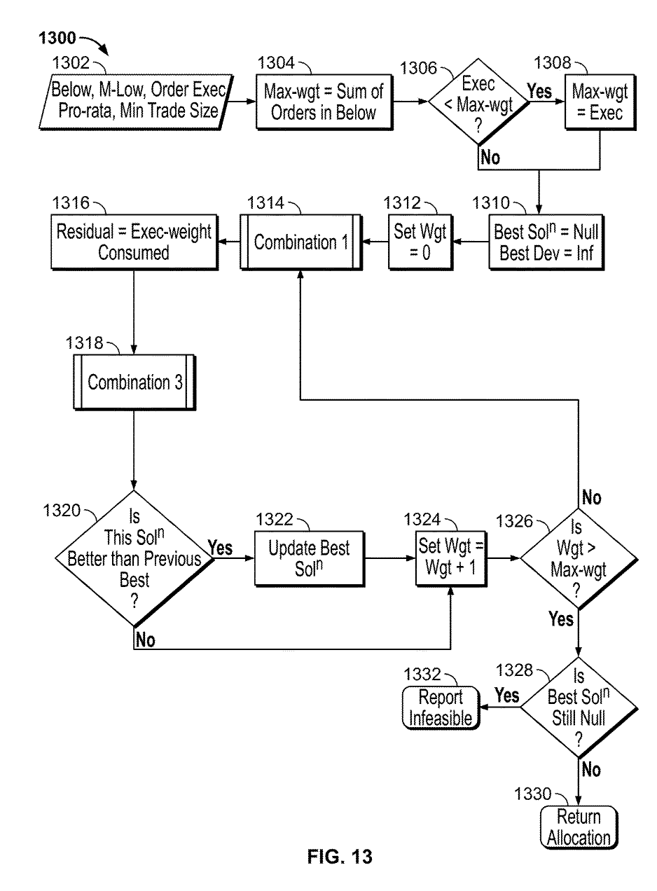

FIG. 13 is a flow chart of an illustrative process for implementing a sixth sub-routine of the allocation process for a sell order. The illustrative process 1300 may be carried out by a trading architecture (e.g., trading architecture 100 for allocating trades in FIG. 1 or trading architecture 300 for allocating trades in FIG. 3). In particular, the illustrative process 1300 of FIG. 13 is used to solve the allocation process for a sell order when orders are of type 4 and type 2 only, i.e., orders for a quantity less than or equal to twice the minimum trade size, which can only either be allocated fully or not at all, and orders which are at least twice the minimum trade size and obey the residual greater than the minimum trade size, but have a pro-rata share which is less than the minimum trade size and therefore fail one of the two constraints. At step 1302, the process receives information regarding the type 4 and type 2 orders, the pro-rata shares, the executed amounts or amounts intended to be executed, minimum trade size, and any other relevant inputs. At step 1304, the process sets the maximum weight to be equal to the sum of the orders with a size below the minimum trade size. At step 1306, the process determines whether the executed amount or amount to be executed is strictly less than the maximum weight, and if so proceeds to set the maximum weight to be equal to the executed amount at step 1308. Otherwise, the process proceeds to step 1310, where the best solution is set to be equal to null, and the best deviation is set to be equal to infinity. At step 1312, the weight is set to 0. At step 1314, the process described above as the “knapsack” problem and associate algorithm are executed, and at step 1316 the residual is set to be equal to the executed amount minus the weight consumed. At step 1318 the process 1000 described in relation to FIG. 10, corresponding to combination 3 is executed. At step 1320, the process determines whether the current solution is better than the previous solution, and if so at step 1322 updates the best solution with the current solution. Otherwise, the process proceeds directly to step 1324, where the weight is incremented. At step 1326, the process determines whether the weight is greater than the maximum weight, and if not returns to step 1314. Otherwise, the process proceeds to step 1328 and determines whether the best solution is still null, in which case the process proceeds to step 1332 and reports that allocation is unfeasible. Otherwise, the process proceeds to step 1330 and returns the allocation.

At least one advantage of the exemplary embodiment of FIG. 13 is the ability to identify that only type 4 and type 2 orders are present in the aggregate order, and to more quickly and more efficiently solve for an allocation by taking into account the types of orders present in the aggregate. At least another advantage of the exemplary embodiment of FIG. 13 is the ability to obtain an allocation which is as close to a pro-rata allocation as possible, in a sell scenario, where there is an additional constraint of being unable to leave a non-tradeable loss.

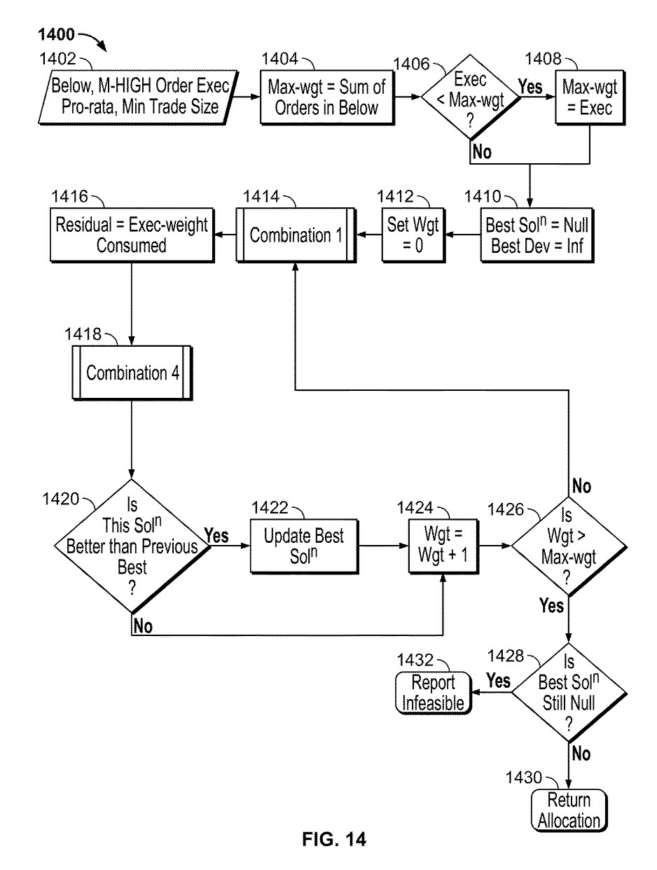

FIG. 14 is a flow chart of an illustrative process for implementing a seventh sub-routine of the allocation process for a sell order. The illustrative process 1400 may be carried out by a trading architecture (e.g., trading architecture 100 for allocating trades in FIG. 1 or trading architecture 300 for allocating trades in FIG. 3). In particular, the illustrative process of FIG. 14 is used to solve the allocation process for a sell order when orders are of type 4 and type 3 only, i.e., orders for a quantity less than or equal to twice the minimum trade size, which can only either be allocated fully or not at all, and orders which are at least twice the minimum trade size and obey the pro-rata quantity greater than or equal to the minimum trade size, but leave a residual which is not 0 and is less than the minimum trade size and therefore fail one of the two constraints.

At step 1402, the process receives relevant inputs such as the accounts below the minimum trade size, minimum trade size, pro-rata allocation amounts, and amount executed or to be executed. At step 1404, the maximum weight is set to be equal to the sum of the orders for the accounts with a pro-rata share below the minimum trade size. At step 1406, the process determines whether the executed amount (or amount to be executed) is less than the maximum weight. If so, at step 1408 the process sets the maximum weight to be equal to the executed amount (or amount to be executed). Otherwise, the process proceeds directly to step 1410, where the best solution is set equal to null and the best deviation is set to be equal to infinity. At step 1412, the weight is set to be equal to 0, and at step 1414 the so-called “knapsack” algorithm is executed before proceeding at step 1416 to set the residual to be equal to the executed amount minus the weight consumed. At step 1418, the process 1100 described in reference to Combination 4 is executed, and at step 1420, the process determines whether the current solution is better than the previous solution. If so, the process proceeds to update the best solution with the current solution at step 1422, before incrementing the weight at step 1424. Otherwise the process proceeds directly from step 1420 to step 1424, and then to step 1426, where it determines whether the weight is greater than the maximum weight. If not, the process returns to step 1414. Otherwise, the process proceeds to determine at step 1428 if the best solution is still null, and if so returns at step 1432 a message that the allocation is unfeasible. Otherwise, the process proceeds to step 1430 and returns the allocation.

At least one advantage of the exemplary embodiment of FIG. 14 is the ability to identify that only type 4 and type 3 orders are present in the aggregate order, and to more quickly and more efficiently solve for an allocation by taking into account the types of orders present in the aggregate. At least another advantage of the exemplary embodiment of FIG. 14 is the ability to obtain an allocation which is as close to a pro-rata allocation as possible, in a sell scenario, where there is an additional constraint of being unable to leave a non-tradeable loss.

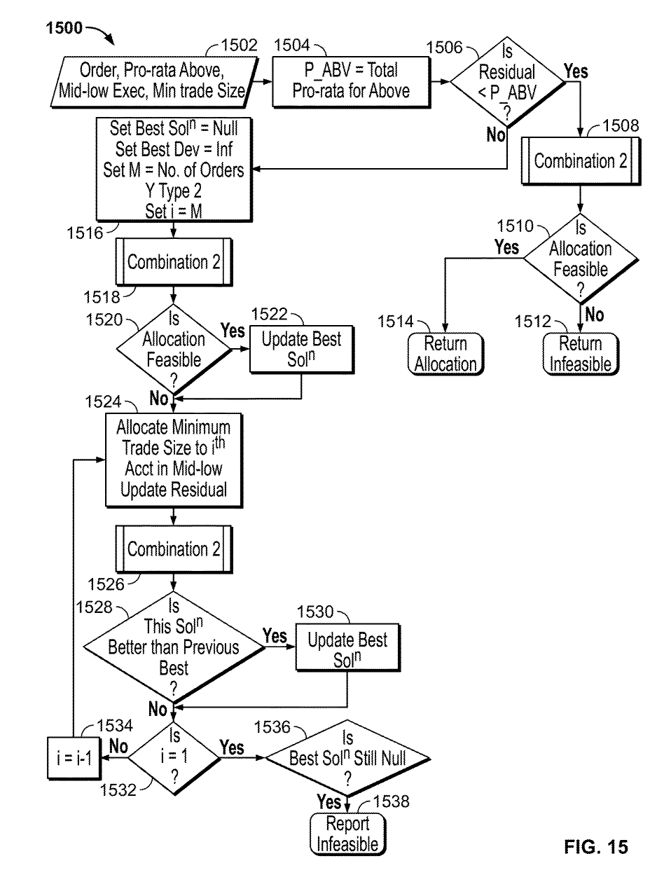

FIG. 15 is a flow chart of an illustrative process for implementing an eighth sub-routine of the allocation process for a sell order. The illustrative process 1500 may be carried out by a trading architecture (e.g., trading architecture 100 for allocating trades in FIG. 1 or trading architecture 300 for allocating trades in FIG. 3). In particular, the illustrative process of FIG. 15 is used to solve the allocation process for a sell order when orders are of type 1 and type 2 only, i.e., orders which obey all constraints on pro-rata (with pro-rata share greater than or equal to the minimum trade size, and the residual greater than or equal to the minimum quantity), and orders which are at least twice the minimum trade size and obey the residual greater than the minimum trade size, but have a pro-rata share which is less than the minimum trade size and therefore fail one of the two constraints.

At step 1502, the process receives relevant inputs such as the pro-rata allocations, the minimum trade size, the executed amounts or amounts to be executed, etc. At step 1504, the process sets a variable P_ABV equal to the total pro-rata amount for the accounts with pro-rata share above the minimum trade size. At step 1506, the process determines whether the residual is strictly less than the P_ABV. If so, the process proceeds to step 1508 which is the process 900 of FIG. 9 for Combination 2, and then determines at step 1510 whether allocation is feasible. If it is, it returns the allocation at step 1514. Otherwise it returns that allocation is unfeasible at step 1512. Returning to step 1506, if the residual is not strictly less than P_ABV, the process sets a best solution equal to “Null”, a best deviation equal to “infinity”, sets M equal to the number of orders of Type 2, sets index i=M, and proceeds to step 1518 where it runs the process 900 of FIG. 9 for Combination 2. At step 1520, the process determines if allocation is feasible, and if so at step 1522 updates the best solution with the current solution. Otherwise, the process proceeds to step 1524, where the process allocates the minimum trade size to the i'th account within Type 2 accounts and updates the residuals, before running process 900 of FIG. 9 again at step 1526. At step 1528, the process determines whether this solution is better than the previous best solution, and if so updates the best solution at step 1530. Otherwise, the process proceeds to step 1532 and determines whether the index i is equal to 1, in which case the process proceeds to step 1536 and determines whether the best solution is still null, in which case it reports that the allocation is unfeasible at step 1538. Otherwise, if i is not equal to 1 at step 1532, the process proceeds to decrement i at step 1534 before returning to step 1524.

At least one advantage of the exemplary embodiment of FIG. 15 is the ability to identify that only type 1 and type 2 orders are present in the aggregate order, and to more quickly and more efficiently solve for an allocation by taking into account the types of orders present in the aggregate. At least another advantage of the exemplary embodiment of FIG. 15 is the ability to obtain an allocation which is as close to a pro-rata allocation as possible, in a sell scenario, where there is an additional constraint of being unable to leave a non-tradeable loss.

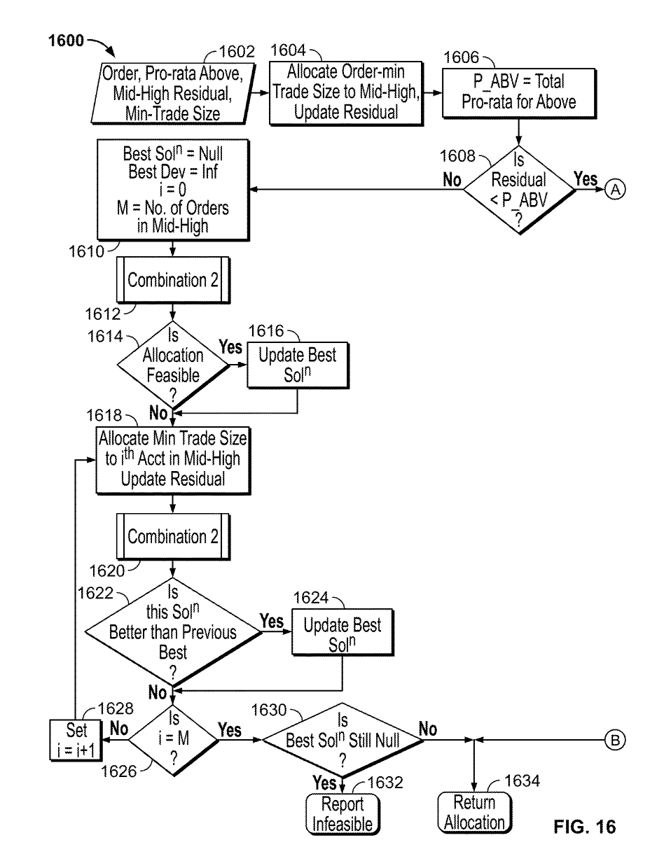

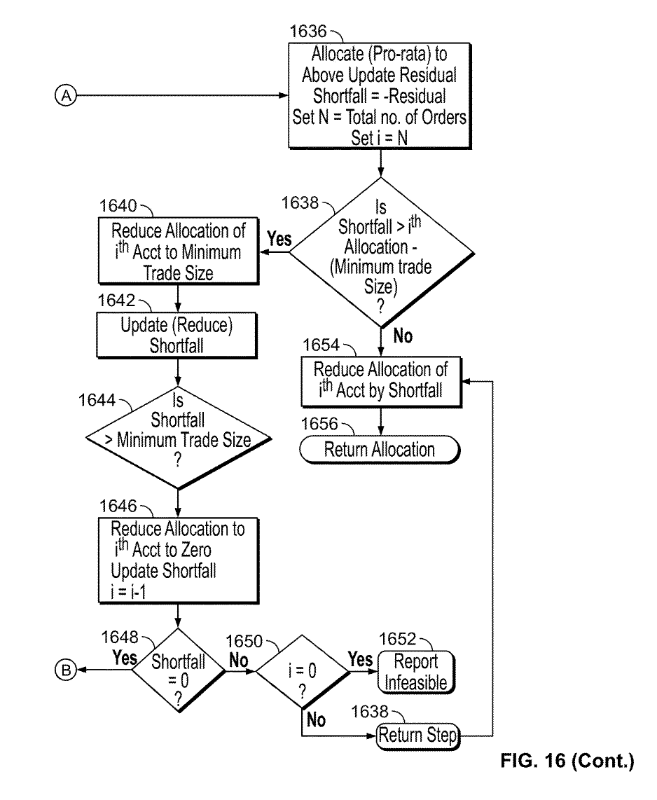

FIG. 16 is a flow chart of an illustrative process for implementing a ninth sub-routine of the allocation process for a sell order. The illustrative process 1500 may be carried out by a trading architecture (e.g., trading architecture 100 for allocating trades in FIG. 1 or trading architecture 300 for allocating trades in FIG. 3). In particular, the illustrative process of FIG. 16 is used to solve the allocation process for a sell order when orders are of type 1 and type 3 only, i.e., orders which obey all constraints on pro-rata (with pro-rata share greater than or equal to the minimum trade size, and the residual greater than or equal to the minimum quantity), and orders which are at least twice the minimum trade size and obey the pro-rata quantity greater than or equal to the minimum trade size, but leave a residual which is not 0 and is less than the minimum trade size and therefore fail one of the two constraints.

At step 1602, the process receives relevant inputs such as the number of orders with a pro-rata share above the minimum trade size, the minimum trade size, etc. At step 1604, the process allocates the ordered amounts minus the minimum trade size, and updates the residual. At step 1606, the process sets a variable P_ABV to be equal to the pro-rata amounts for accounts above the line. At step 1608, the process determines whether the residual is strictly less than the P_ABV, and if so proceeds to step 1636. Otherwise, the process proceeds to step 1610 and sets the best solution to be “null,” the best deviation to be infinity, index i to be 0, and M to be the number of orders of Type 3. At step 1612, the process 900 of FIG. 9 is executed, and at step 1604, the process determines whether allocation is feasible. If so, at step 1616 the process updates the best solution. Otherwise, the process proceeds to step 1618 and allocates the minimum trade size to the i'th account among Type 3 orders and updates the residuals, before proceeding to step 1620 where process 900 of FIG. 9 is run. At step 1622, the process determines whether the current solution is better than the previous best solution, and if so updates the best solution with the current solution at step 1624. Otherwise, the process proceeds to step 1626 and determines whether index i is equal to M. If so, the process proceeds to determine at step 1630 whether the best solution is still null, and if so reports that allocation is infeasible at step 1632. Otherwise if the best solution is not still null the process proceeds to step 1634 and returns the allocation.

Returning to step 1636, the process allocates pro-rata to the accounts above the minimum trade size, and updates the residual. The process also determines a shortfall equal to the negative of the residual, and sets N equal to a total number of orders, and index i=N. At step 1638, the process determines whether the shortfall is strictly greater than the i'th allocation minus the minimum trade size. If not, at step 1654 the process reduces the allocation of the i'th account by the shortfall, and at step 1656 returns the allocation. If yes, the process proceeds to step 1640 and reduces the allocation of the i'th account to the minimum trade size, before proceeding to step 1642 to update (i.e., reduce) the shortfall. At step 1644, the process determines whether the shortfall is still strictly greater than the minimum trade size. If so, the process proceeds to step 1646 and reduces the allocation for the i'th account to 0, updates the shortfall and decrements I before proceeding to step 1648 where it determines whether the shortfall is 0. If the shortfall is 0, the process returns to step 1634 and returns the allocation. If the shortfall is not 0, the process determines at step 1650 whether the index i is 0, and if so reports that allocation is unfeasible at step 1652. Otherwise the process proceeds to step 1654 and returns to step 1638.

At least one advantage of the exemplary embodiment of FIG. 16 is the ability to identify that only type 1 and type 3 orders are present in the aggregate order, and to more quickly and more efficiently solve for an allocation by taking into account the types of orders present in the aggregate. At least another advantage of the exemplary embodiment of FIG. 16 is the ability to obtain an allocation which is as close to a pro-rata allocation as possible, in a sell scenario, where there is an additional constraint of being unable to leave a non-tradeable loss.

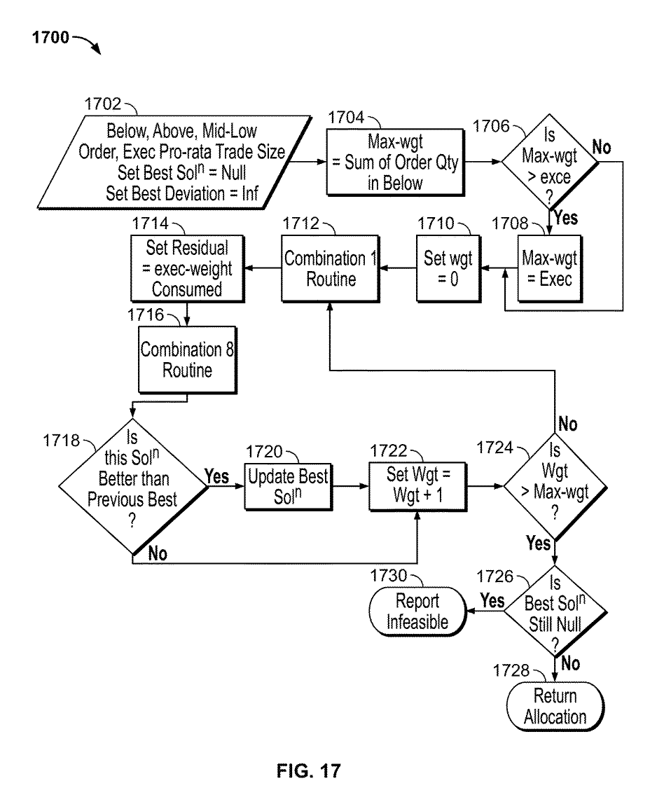

FIG. 17 is a flow chart of an illustrative process for implementing a tenth sub-routine of the allocation process for a sell order. The illustrative process 1700 may be carried out by a trading architecture (e.g., trading architecture 100 for allocating trades in FIG. 1 or trading architecture 300 for allocating trades in FIG. 3). In particular, the illustrative process of FIG. 17 is used to solve the allocation process for a sell order when orders are of type 1, 2 and 4 only, i.e., orders which obey all constraints on pro-rata (with pro-rata share greater than or equal to the minimum trade size, and the residual greater than or equal to the minimum quantity), orders which are at least twice the minimum trade size and obey the residual greater than the minimum trade size, but have a pro-rata share which is less than the minimum trade size and therefore fail one of the two constraints, and orders which are for a quantity less than or equal to twice the minimum trade size, which can only either be allocated fully or not at all.

At step 1702, the process receives various relevant inputs such as the accounts below or above the minimum trade size, the executed amount or amount to be executed, the pro-rata amounts, the minimum trade size, etc. The process also sets the best solution to be equal to “null” and the best deviation to be equal to “infinity.” At step 1704, the process sets the maximum weight to be equal to the sum of the ordered quantity for the accounts having a pro-rata share below the minimum trade size. At step 1706, the process determines whether the maximum weight is strictly greater than the executed amount. If not the process proceeds directly to step 1710. Otherwise, the process proceeds to step 1708 and sets the maximum weight to be equal to the executed amount. At step 1710 the process sets the weight equal to 0, and at step 1712 the process runs the so-called “knapsack” algorithm before setting the residual equal to the executed amount minus the weight consumed, at step 1714. At step 1716, the Combination 8 algorithm (corresponding to process 1500 of FIG. 5) is run, and the method proceeds to step 1718 where it determines whether the current solution is better than the previous best solution. If so, at step 1720 the process updates the best solution, and at step 1722 increments the weight. Otherwise, the process proceeds directly to step 1722. At step 1724, the process determines whether the weight is strictly greater than the maximum weight. At step 1726, the process determines whether the best solution is still null, and if so reports at step 1730 that allocation is unfeasible. Otherwise the process proceeds to step 1728 and returns the allocation.

At least one advantage of the exemplary embodiment of FIG. 17 is the ability to identify that only type 1, 2 and 4 orders are present in the aggregate order, and to more quickly and more efficiently solve for an allocation by taking into account the types of orders present in the aggregate. At least another advantage of the exemplary embodiment of FIG. 17 is the ability to obtain an allocation which is as close to a pro-rata allocation as possible, in a sell scenario, where there is an additional constraint of being unable to leave a non-tradeable loss.

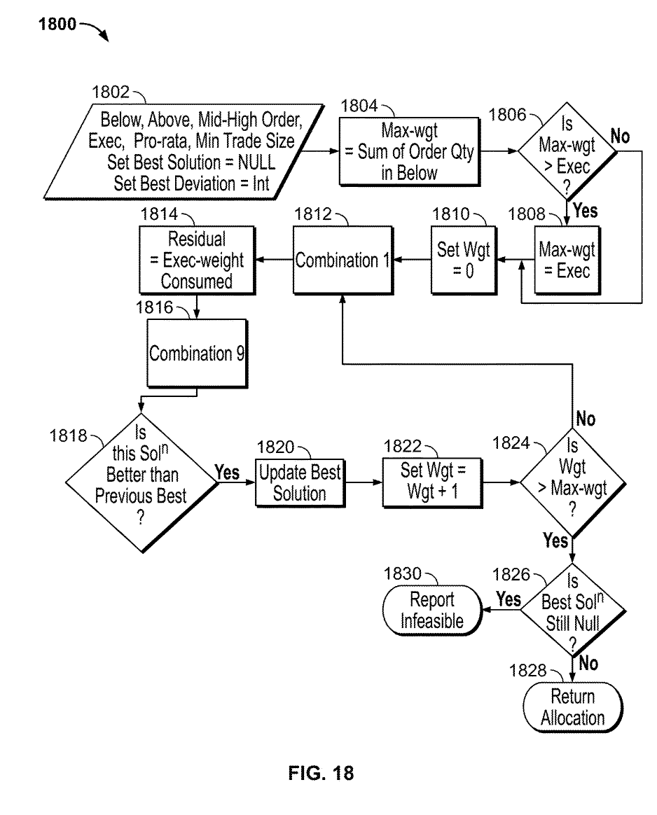

FIG. 18 is a flow chart of an illustrative process for implementing an eleventh sub-routine of the allocation process for a sell order. The illustrative process 400 may be carried out by a trading architecture (e.g., trading architecture 100 for allocating trades in FIG. 1 or trading architecture 300 for allocating trades in FIG. 3). In particular, the illustrative process 1800 of FIG. 18 is used to solve the allocation process for a sell order when orders are of type 1, 3 and 4 only, i.e., orders which obey all constraints on pro-rata (with pro-rata share greater than or equal to the minimum trade size, and the residual greater than or equal to the minimum quantity), orders which are at least twice the minimum trade size and obey the pro-rata quantity greater than or equal to the minimum trade size, but leave a residual which is not 0 and is less than the minimum trade size and therefore fail one of the two constraints, and orders which are for a quantity less than or equal to twice the minimum trade size, which can only either be allocated fully or not at all.

At step 1802, the process receives relevant inputs such as the accounts with pro-rata shares below or above the minimum trade size, the minimum trade size, etc. The process also sets the best solution equal to null and sets the best deviation equal to infinity. At step 1804, the maximum weight is set to be the sum of the ordered quantities for the accounts with pro-rata shares below the minimum size. At step 1806, the process determines whether the maximum weight is strictly greater than the executed amount (or amount to be executed). If not, the process proceeds directly to step 1810. Otherwise, the process at step 1808 sets the maximum weight to be equal to the executed amount (or amount to be executed). At step 1810 the weight is set to equal 0. At step 1812, the so-called “knapsack” process corresponding to combination 1 is implemented. At step 1814, the residual is set to be equal to the executed amount minus the weight consumed. At step 1816 the algorithm corresponding to Combination 9 (corresponding to process 1600 discussed in relation to FIG. 16) is run, and at step 1818 the process determines whether the current solution is better than the previously best solution. If so, at step 1820 the process updates the best solution, and at step 1822 increments the weight. At step 1824, the process determines whether the weight is strictly greater than the maximum weight. If not, the process returns to step 1812. If yes, the process proceeds to step 1826 to determine whether the best solution is still null, and if so report at step 1830 that the allocation is unfeasible. Alternatively, at step 1828 the process reports the allocation.

At least one advantage of the exemplary embodiment of FIG. 18 is the ability to identify that only type 1, 3 and 4 orders are present in the aggregate order, and to more quickly and more efficiently solve for an allocation by taking into account the types of orders present in the aggregate. At least another advantage of the exemplary embodiment of FIG. 18 is the ability to obtain an allocation which is as close to a pro-rata allocation as possible, in a sell scenario, where there is an additional constraint of being unable to leave a non-tradeable loss.

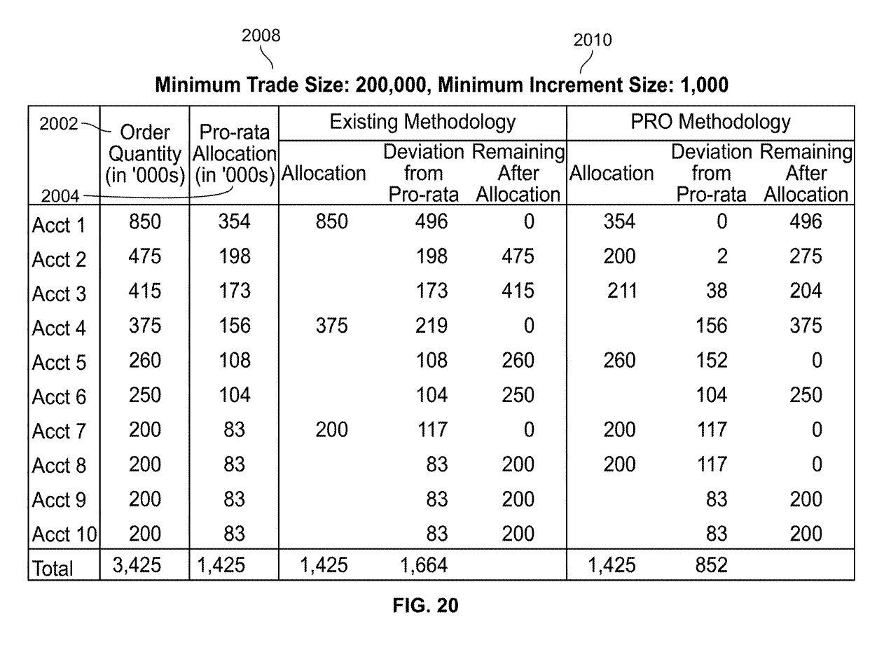

FIG. 20 is a table describing an illustrative process for allocating a block sell order. For example the table describes an illustrative process 2000, similar to illustrative processes 800-1800. Compared to a buy order, a sell order requires compliance with one additional constraint with respect to minimum residual quantity—no non-tradeable lot may remain. An order quantity 2002 is indicated for each account, and a pro-rata allocation quantity 804 is computed for each account. A minimum trade size 2008 is 200,000 in this exemplary embodiment, and a minimum increment size 2010 is 1,000 in this exemplary embodiment. The table compares an existing strict pro-rata methodology with the modified pro-rata methodology, for example according to the illustrative process 800 of FIG. 8, along with deviations from pro-rata allocation and amount remaining after allocation. In the example shown in FIG. 20, because a large pro-rata portion of the order was in accounts that fell “below the line” a strict pro-rata methodology gives a full fill to the largest order and then creates just two additional allocations to accounts below the line. In contrast, a process such as illustrative process 800 described in FIG. 8 allocates to more accounts while reducing the deviation from pro-rata by 49%, with no manual intervention.

Use of the illustrative processes of FIGS. 4-18 and 21 is preferable to the use of optimizers. However, in an exemplary embodiment, the optimal algorithms of FIGS. 8-18 may be replaced by or complemented by building one or more optimization problems, requiring longer processing times than the algorithms of FIGS. 8-18 to be solved, and inputting this optimization problem into a solver which may run on an illustrative architecture such as illustrative architecture 300 of FIG. 3.

$$\begin{matrix}Minimize & c * x \\ s . t . & A * x \leq b \\ & 1 \geq x \geq 0\end{matrix}$$

$$c = [ {e}_{n} , {O}_{n} , {O}_{n} , {O}_{n} ]$$

$$A = [ \begin{matrix}- {I}_{n} & \frac{H}{T} {I}_{n} & {OO}_{n} & {OO}_{n} \\ - {I}_{n} & - \frac{H}{T} {I}_{n} & {OO}_{n} & {OO}_{n} \\ {OO}_{n} & - H * {I}_{n} & M * {I}_{n} & {OO}_{n} \\ {OO}_{n} & H * {I}_{n} & - diag ( min ( T , {ord}_{n} ) ) & {OO}_{n} \\ {O}_{n} & H * {e}_{n} & {O}_{n} & {O}_{n} \\ {OO}_{n} & - H * {I}_{n} & {OO}_{n} & diag ( {ord}_{n} ) \\ {OO}_{n} & H * {I}_{n} & {OO}_{n} & diag ( {ord}_{n} - M - T )\end{matrix} ]$$

$$b = [ {d}_{n} , - {d}_{n} , {O}_{n} , {O}_{n} , T , {O}_{n} , ( {ord}_{n} - M ) ]$$

Fifth constraint is equality
eₙ is a 1-vector of n length
Oₙ is a 0-vector of n length
dₙ is standard pro-rata % vector of n length
ordₙ is open order quantity vector of n length
Iₙ is unit diagonal matrix of dimension n
OOₙ is zero matrix of dimension n, n
diag(ordₙ) is diagonal matrix of dimension n with ordₙ as diagonal
M is execution minimum and T is executed quantity
H is minimum increments

At least one advantage of the method described in FIG. 8-18, is the ability to obtain allocation results much more quickly than via the above optimizer method, and the ability to use an existing architecture such as illustrative architecture 100 in FIG. 1.

FIG. 21 is a flow chart of an illustrative process 900 for allocating a MUNI New Issue order. The illustrative process 400 may be carried out by a trading architecture (e.g., trading architecture 2100 for allocating trades in FIG. 1 or trading architecture 300 for allocating trades in FIG. 3). New issue municipal bond trades present an additional complexity due to the presence of range of CUSIPs that are offered as part of the deal. In one example, various CUSIPs of the new issue may be treated as equivalent. In this example, accounts may be to a range of CUSIPs to fulfill the quantity ordered for each account. However, issuers and/or other parties may impose minimums per CUSIP that can be allocated to each account. For example, a management company may order $500,000 par for an account with a $250,000 minimum par/CUSIP. For a new issue offering containing two separate CUSIPs the trade may be allocated with $250,000 par of each CUSIP allocated to the account to fulfill the ordered quantity of $500,000 par. With range orders in MUNI new issues, it may be preferable to minimize the number of allocations required to fulfill the ordered quantity. For example, for a MUNI new issue with a range containing 4 CUSIPs, a larger allocation of I CUSIP to fulfill the order may be preferable to two allocations in separate CUSIPs because it marginally increases the liquidity of a client portfolio.

For example, illustrative process 2100 may be the process selected to be run at step 424 of FIG. 4 and implemented as a computer algorithm. At step 2102, the process receives orders, a minimum trade size, CUSIP executions, an incremental quantity, and any other constraints. At step 2104, the process solves a buy problem for example with the illustrative process 500 of FIG. 5 with respect to the sum of all the orders across all CUSIPs, and proceeds to determine at step 2106 whether the allocation is feasible. In the event that allocation is not feasible overall (as solved at step 2104), the process proceeds to step 2108, where it reports infeasibility of allocation. Alternatively, the process proceeds to step 2110 where an optimization model can be built to minimize the deviation from pro-rata, and the incremental quantity constraint can be relaxed to create a new model. At step 2112, a solver may be invoked to minimize the deviation for the model created at step 2110. At step 2114, the optimal solution of the model can be obtained. At step 2116, constraints may be added to enforce a solution that is bound between a floor and a ceiling. At step 2118, the process can enforce a discrete increment quantity constraint to get a new model. At step 2120, a solver may be invoked to minimize the deviation for this new model, and at step 2122 an optimal deviation of the new model is obtained. At step 2124, the process may add a constraint that the deviation be less than or equal than the sum of the deviation obtained at step 2122 and an increment epsilon. At step 2124, the process may also change the optimization objective to be the count of total allocations, and modify the constraints to obtain a new model. At step 2126, a solver may be invoked to minimize the allocation count for the new model created at step 2124. At step 2128, the process can obtain the optimal solution for the model of step 2126, at step 2130, the process may add a constraint to enforce the solution being bound between a floor and a ceiling. At step 2132, the optimization objective may again be changed to be the total deviation of the solution, with modified constraints of increment quantity to create a new model. At step 2134 a solver may be invoked to solve this new model, and at step 2136 an allocation may be returned.

In an exemplary embodiment of process 2100, the process may access a database linking account level minimum and break points, and rely on this database to determine account level minimum for each of the accounts. For example, for MUNI new issues the minimum lot size may be tailored to individuals rather than institutions, and transacting in small lots incurs substantially greater transaction costs for clients. The database may link account-level minimums based on Account Under Management (AUM) amounts and observed break points in transaction costs using market data. For example, the database may link AUMs below $75 mm to no minimum, AUMs between $75-700 M to a minimum trade size of $100 k, and AUMs of over $700 M to a minimum trade size of $1 M. At step 916, the process allocates the n CUSIPs to the m accounts, subject to the determined account level minimums for each of the m accounts and minimizing a number of line items, defined as unique combinations of CUSIPs and accounts.

At least one advantage of the illustrative process 2100 is the ability to accommodate the serialized nature of municipal bond issuance, which includes range orders, such that an account may be allotted any of the bonds within a specified range. Other than illustrative process 2100, there is no known systematic solution for orders that may be filled with a range of possible securities (e.g., multiple CUSIPS with varying maturities and coupon rates), such as MUNI new issues. For example, in a simulation the illustrative process 2100 allocates all of the accounts in 95% of the scenarios.

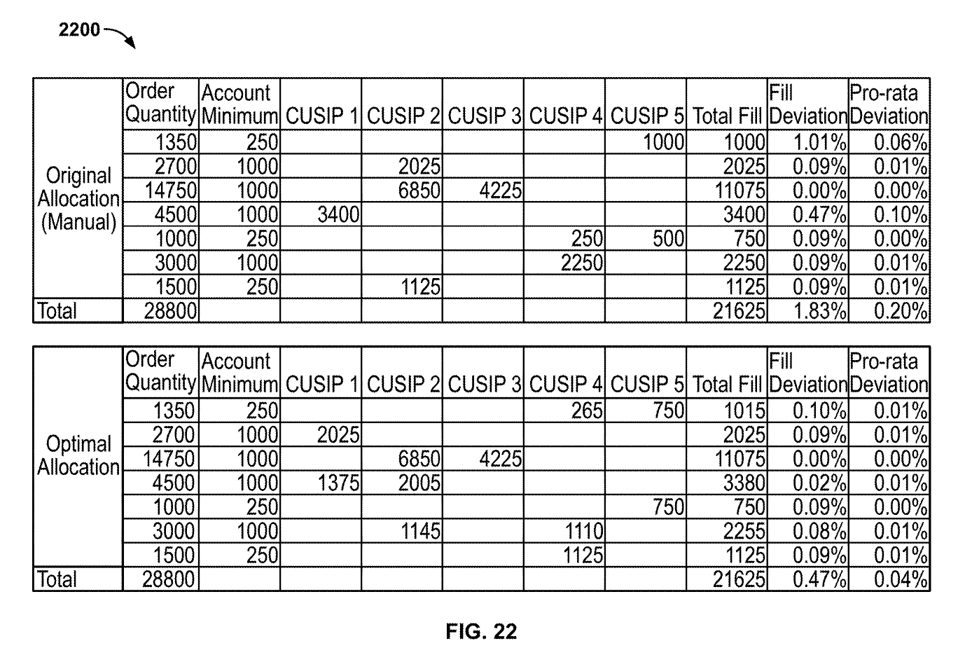

FIG. 22 is a table describing an illustrative process for allocating a MUNI New Issue order. For example the table describes an illustrative process 2200 similar to illustrative process 2100 of FIG. 21. FIG. 22 shows an original (manual) allocation between 7 accounts and 5 CUSIPs. FIG. 22 also shows an optimal allocation between the 7 accounts and the 5 CUSIPs, resulting for example from the illustrative process 2100 of FIG. 21. In one example, a simulation of the illustrative process of FIG. 21, run over 38,413 samples, with account allocation minimums based on AUM, for 4-7 accounts with 3-7 CUSIPs and account sizes ranging from 100 M to 2 B with order sizes from 0.25% to 5% of AUM resulted in an average total deviation from pro-rata of 5%, and only 2.21% of accounts not allocated.

Use of the illustrative processes of FIGS. 4-18 and 21 is preferable to the use of optimizers. However, in an exemplary embodiment, the method of FIGS. 21-22 may be replaced by or complemented by building one or more optimization problems based on inputs from the trade order, as described below with a multi-objective optimization framework where a primary objective is to minimize deviation from pro-rata and a secondary objective is to minimize the total number of allocations made. These optimization problems require longer processing times than the algorithms of FIG. 21 to be solved, but this optimization problem may be input into a solver which may run on an illustrative architecture such as illustrative architecture 300 of FIG. 3.

Parameters:
i=1, 2, . . . , n: Index representing the n clients
j=1, 2, . . . , m: Index representing them CUSIPs offered as part of the deal
Mᵢ: Minimum allocation size for client i
Tⱼ: Total executed size in CUSIP j
T: Total executed size across all CUSIPs
H: Minimum increments
dᵢ, standard pro-rata allocation percentage for client i based on order submission quantities
oᵢ, open order quantity for client i

Variables:
H*xᵢⱼ, allocation to client i in CUSIP j
yᵢⱼ, binary decision to allocate CUSIP j to client i, or not

Primary Objective Function:
Minimize Σᵢ₌₁ⁿ|Σⱼ₌₁^{m}H*xᵢⱼ/T−dᵢ|:
Sum of absolute deviations from pro-rata allocation %.

Secondary Objective Function:
Minimize Σᵢ₌₁ⁿΣⱼ₌₁^{m}yᵢⱼ:
Total count of allocations

Constraints:
Σᵢ₌₁ⁿH*xᵢⱼ≦Tⱼ, j=1, . . . m: Allocation across all accounts should sum≦executed quantity
Σᵢ₌₁^{m}H*xᵢⱼ≦oᵢ, i=1, . . . n: Allocation to account≦ordered quantity
Mᵢ*yᵢⱼ≦H*xᵢⱼ≦min(oᵢ, Tⱼ)*yᵢⱼ, i=1, . . . n; j=1, . . . m: If yᵢ=0, xᵢ=0, else H*xᵢ≧minimum allocation size
xᵢⱼ εpositive integer, i=1, . . . n; j=1, . . . m: Allocation has to be non-negative
yᵢⱼ in {0, 1}, i=1, . . . n; j=1, . . . m: Binary variable, either to allocate or not

A matrix formulation is provided below.

$$\begin{matrix}Minimize & c * x \\ s . t . & A * x \leq b \\ & 1 \geq x \geq 0\end{matrix}$$

$$c = [ {e}_{n} , {O}_{nm} , {O}_{nm} ]$$

$$A = [ \begin{matrix}- {I}_{n} & \frac{H}{TT} e ( {I}_{n} , m ) & {OO}_{n , nm} \\ - {I}_{n} & - \frac{H}{TT} e ( {I}_{n} , m ) & {OO}_{n , nm} \\ {OO}_{nm , n} & - {diag}_{nm} ( H ) & DM \\ {OO}_{nm , n} & {diag}_{nm} ( H ) & - min ( DT , DO ) \\ {OO}_{m , n} & H * S & {OO}_{m , nm} \\ {OO}_{n , n} & H * e ( {I}_{n} , m ) & {OO}_{n , nm}\end{matrix} ]$$

$$b = [ {d}_{n} , - {d}_{n} , {O}_{nm} , {O}_{nm} , T , {ord}_{n} ]$$

Fifth constraint is equality
eₙ is a 1-vector of n length
Oₙ is a 0-vector of n length
dₙ is standard pro-rata % vector of n length
Iₙ is unit diagonal matrix of dimension n
e(Iₙ, m) ism vector of Iₙ
OO_{n,nm} is zero matrix of dimension n and nm
T is m-vector of CUSIP total executions
TT is sum of T
M is n-vector of account minimum quantity
H is minimum increments
ordₙ is open order quantity vector of n length
DT is diag matrix of size nm; diag=rep(T, each=n)
DM is diag matrix of size nm; diag=rep(M, times=m)
DO is diag matrix of size nm; diag=rep(ordₙ, times=m)
S is a matrix of size m, nm with 0 in columns except at

$$row = ceiling ( \frac{i}{n} ) , i = 1 , … , nm$$

At least one advantage of the method described in FIG. 21, is the ability to obtain allocation results much more quickly than via the above optimizer method, and the ability to use an existing architecture such as illustrative architecture 100 in FIG. 1.

A data checking system may be run in parallel to the systems and methods described herein. For example, a program running on open source code may determine a plurality of allocations for a given set of trading accounts. These allocations may be compared to the allocations determined by the system and methods described herein. If there are large discrepancies between the two pluralities of allocations, a notification signal may be generated for a user. The notification signal may instruct the user to manually check these allocations.

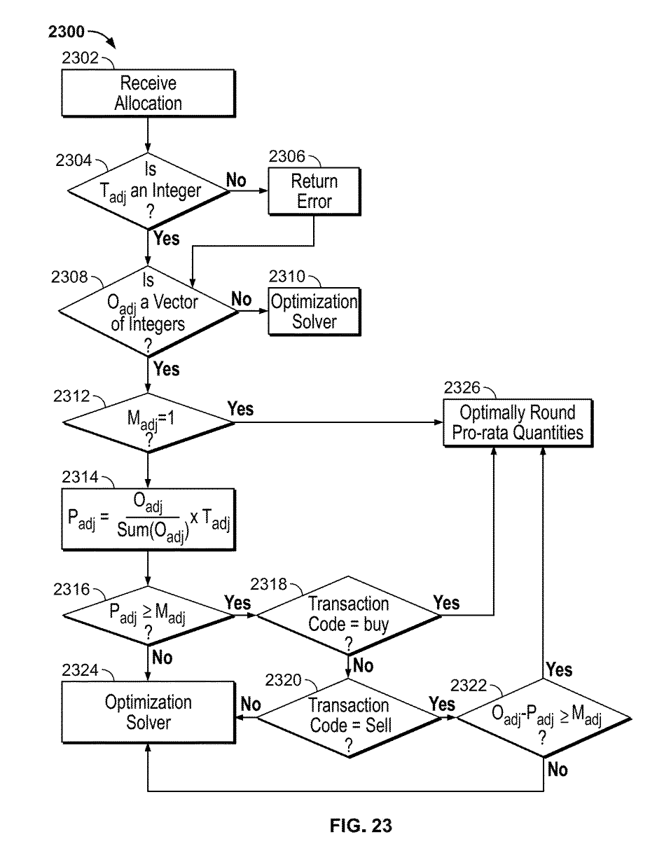

FIG. 23 is a flow chart of an illustrative process for implementing a data check of an allocation. The illustrative process 2300 may be carried out by a trading architecture (e.g., trading architecture 2100 for allocating trades in FIG. 1 or trading architecture 300 for allocating trades in FIG. 3) or a computer system. As used herein, O is a variable representing a vector of order quantities, T is a variable representing an executed quantity, M is a variable representing a minimum trade size, and N a variable representing is a minimum increment size. As used herein, O_{adj} is a variable representing a vector of values calculated by dividing O (the vector of order quantities) by N (the minimum increment size). As used herein, T_{adj} is a variable representing T (the executed quantity) divided by N (the minimum increment size). As used herein, M_{adj} is a variable representing M (the minimum trade size) divided by N (the minimum increment size). This process may be used, for example, to check whether an allocation needs to be completed through optimal rounding of the pro-rata quantities or through an optimization solver, such as Gurobi.

Process 2300 determines whether optimal rounding of pro-rata allocation will suffice or whether an optimization solver must be used for an allocation. If any of the following three conditions apply, optimal rounding of pro-rata quantities will provide an appropriate allocation. If none of the following conditions apply, an optimization solver, such as that described above, must be used. The conditions are:
1) M_{adj}=1
2) Transation code=“buy” and every value of P_{adj}≧M_{adj}
3) Transaction code=“sell” and every value of P_{adj}≧M_{adj} and every value of O_{adj}−P_{adj}≧M_{adj}
   This process constitutes a “data check” that can inform a user of the reliability of a given allocation, such as an allocation determined by the systems and methods described above.

Process 2300 begins at step 2302, where the process receives the allocation. The allocation includes defined values for variables O, T, M, and N. The process calculates O_{adj}, T_{adj}, and M_{adj} using the received values of O, T, M, and N. At step 2304, the process determines whether T_{adj} (the executed quantity adjusted by the minimum increment size) is an integer. If T_{adj} is not an integer, process 2300 continues to step 2306, where the process returns an error. This error may, for example, display “Executed quantity not multiple of minimum increment” to a user of the process.

If T_{adj} is an integer, the process continues to step 2308, where the process determines whether O_{adj} is a vector of integers. If any value in the vector O_{adj} is not an integer, O_{adj} is not a vector of integers and process 2300 continues from step 2308 to step 2310. At step 2310, the process enters an optimization solver, such as Gurobi. If O_{adj} is a vector of integers, the process continues from step 2308 to step 2312 where the process determines if M_{adj} is equal to 1. If M_{adj} is equal to one, process 2300 continues from step 2312 to step 2326, where the process optimally rounds pro-rata quantities. If M_{adj} is not equal to one, process 2300 continues from step 2312 to step 2314, where the process calculates P_{adj} by dividing O_{adj} by the sum of the values of vector O_{adj} and multiplying this divided value by T_{adj}.

Process 2300 continues from step 2314 to step 2316, where the process determines whether each value of vector P_{adj} is greater than or equal to M_{adj}. If each value of vector P_{adj} is not greater than or equal to M_{adj}, process 2300 continues from step 2316 to step 2324, where the process enters an optimization solver. If each value of vector P_{adj} is greater than or equal to M_{adj}, process 2300 continues from step 2316 to step 2318, where the process determines whether the transaction code is “buy”. If the transaction code is “buy”, process 2300 continues from step 2318 to step 2326, where the process optimally rounds pro-rata quantities.

If the transaction code is not “buy”, process 2300 continues from step 2318 to step 2320 where the process determines whether the transaction code is “sell”. If the transaction code is “sell”, process 2300 continues from step 2320 to step 2322, where the process determines whether O_{adj}−P_{adj} is greater than or equal to M_{adj}. If O_{adj}−P_{adj} is greater than or equal to M_{adj}, process 2300 continues from step 2322 to step 2326, where the process optimally rounds the pro-rata quantities. If O_{adj}−P_{adj} is not greater than or equal to M_{adj}, process 2300 continues from step 2322 to step 2324, where the process enters the optimization solver. If the transaction code is not “sell”, process 2300 continues from step 2320 to step 2324, where the process enters the optimization solver as described above.

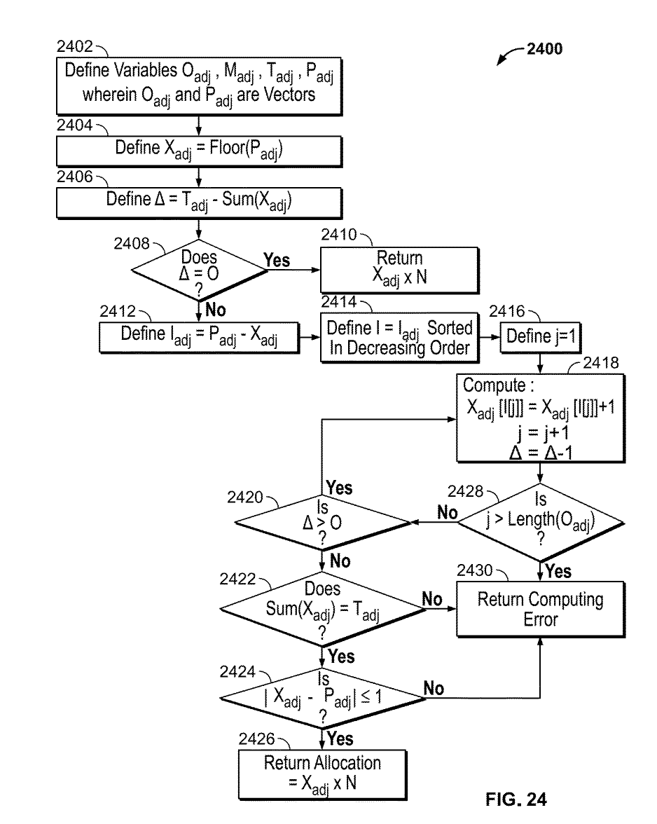

FIG. 24 is a flow chart of an illustrative process for implementing a rounding algorithm that can be used to optimally round pro-rata allocations. Process 2400 begins at step 2402, where the process defines variables O_{adj}, M_{adj}, T_{adj}, and P_{adj}, as described above in relation to FIG. 23. At step 2404 the process defines X_{adj} as the floor of P_{adj}, i.e., every value in the vector P_{adj} is rounded down to the nearest integer less than the value. For example, if Padj is [0.1, 1.7, 2.3], the floor of Padj is [0, 1, 2]. Process 2400 continues to step 2406, where Δ is defined as the summation of the values of X_{adj} subtracted from T_{adj}. Process 2400 continues to 2408, where the process determines whether Δ is equal to zero. If Δ equals zero, the process continues to step 2410, where Xadj is multiplied by N and returned.

If Δ does not equal zero, process 2400 continues from step 2408 to step 2412, where I_{adj} is defined as X_{adj} subtracted from P_{adj}. Process 2400 continues from step 2412 to step 2414 where the process sorts I_{adj} in decreasing order to compute vector. The result of this sorting is vector I. Process 2400 continues to step 2416 where a counter j is set equal to 1. Process 2400 continues to step 2418 where the process updates three values: X_{adj}, j, and Δ. The process computes X_{adj} [I[j]]=X_{adj} [I[j]]+1, j=j+1, and Δ=Δ−1.

At step 2428, the process determines whether j is greater than the length of vector O_{adj}. If j is greater than the length of O_{adj}, the process returns a computing error. If j is not greater than the length of O_{A}, process 2400 continues from step 2428 to step 2420, where the process determines whether Δ is greater than zero. If Δ is greater than zero, process 2400 returns to step 2418. Steps 2418. 2428, and 2420 create a loop that iteratively increases counter j, decreases the value of Δ, and therefore loops through the values of X_{adj}.

If Δ is less than or equal to zero the process exits the loop formed by steps 2418, 2428, and 2420 and the process continues from step 2420 to step 2422, where the process determines if the summation of the values of X_{adj} equals T_{adj}. If the summation of the values of X_{adj} does not equal T_{adj}, process 2400 continues from step 2422 to step 2430, where the process returns a computing error. If the summation of the values of X_{adj} does equal T_{adj}, process 2400 continues from step 2422 to step 2424, where the process determines whether the absolute value of X_{adj} minus P_{adj} is less than or equal to 1. If the absolute value of X_{adj} minus P_{adj} is less than or equal to 1, the process returns the allocation equal to X_{adj} multiplied by N at step 2426. If the absolute value of X_{adj} minus P_{adj} is not less than or equal to 1, the process returns a computing error at step 2430.

In an alternative embodiment, some of the embodiments described above may be combined. For example, the buy embodiment of FIG. 5 and the sell embodiment of FIG. 8 requests may be combined when linked orders are received: orders which are buy or sell orders conditioned on sell or buy orders, respectively.

Some embodiments and processes of the present disclosure may be conveniently implemented using a conventional general purpose or a specialized digital computer or microprocessor programmed according to the teachings herein, as will be apparent to those skilled in the computer art. For example, embodiments and processes may be carried out by a trading architecture such as trading architecture 100 for allocating trades in FIG. 1 or trading architecture 300 for allocating trades in FIG. 3. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art would understand that information and signals may be represented using any of a variety of different technologies and techniques. For example, data, instructions, requests, information, signals, bits, symbols and chips that may be references throughout the above description may be represented by voltages, currents, electromagnetic waves, magnetic fields or particles, optical fields or particles, or any combination thereof. Some embodiments may be implemented using existing parallel, distributed computer processing and distributed data storage frameworks (e.g., Hadoop).

Some embodiments include a computer program product comprising a computer readable medium (media) having instructions stored thereon/in and, when run (e.g., by a processor), perform methods, techniques, or embodiments described herein, the computer readable medium comprising sets of instructions for performing various steps of the methods, techniques, or embodiments described herein. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in. Additionally, the storage medium may be a hybrid system that stored data across different types of media, such as flash media and disc media. Optionally, the different media may be organized into a hybrid storage aggregate. In some embodiments different media types may be prioritized over other media types, such as the flash media may be prioritized to store data or supply data ahead of hard disk storage media or different workloads may be supported by different media types, optionally based on characteristics of the respective workloads. Additionally, the system may be organized into modules and supported on blades configured to carry out the storage operations described herein.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general purpose/specialized computer or microprocessor are software modules for implementing some embodiments.

Those of skill would further appreciate that the various illustrative logical blocks, modules, circuits, techniques, or method steps of embodiments described herein may be implemented as electronic hardware, computer software, or combinations of both. To illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the embodiments described herein.

The various illustrative logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The foregoing is merely illustrative of the principles of the disclosure, and the systems, devices, and methods described herein are presented for purposes of illustration, and not of limitation. The techniques or steps of a method described in connection with the embodiments disclosed herein may be embodied directly in hardware, in software run or executed by a processor, or in a combination of the two. In some embodiments, any software module, software layer, or thread described herein may comprise an engine comprising firmware or software and hardware configured to perform embodiments described herein. In general, functions of a software module or software layer described herein may be embodied directly in hardware, or embodied as software run or executed by a processor, or embodied as a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

Variations and modifications will occur to those of skill in the art after reviewing this disclosure. The disclosed features may be implemented, in any combination and subcombination (including multiple dependent combinations and subcombinations), with one or more other features described herein. The various features described or illustrated above, including any components thereof, may be combined or integrated in other systems. Moreover, certain features may be omitted or not implemented. Examples, changes, substitutions, and alterations ascertainable by one skilled in the art can be made without departing from the scope of the information disclosed herein.

It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, and/or method described herein. In addition, any combination of two or more such features, systems, and/or methods, if such features, systems, and/or methods are not mutually inconsistent, is included within the inventive scope of the present disclosure.

What is claimed is:

1. A method for allocating trades in a financial instrument between client accounts, the method comprising:
determining, using processing circuitry, a financial instrument for a trade;
determining, using the processing circuitry, a plurality of accounts for trading in the financial instrument;
aggregating, using the processing circuitry, orders for the financial instrument from the plurality of accounts;
determining, using the processing circuitry, a pro-rata allocation of the orders for the financial instrument, from the plurality of accounts;
determining whether there are accounts, from the plurality of accounts, with a pro-rata share below a minimum amount;
based on the determining that there are accounts, from the plurality of accounts, with a pro-rata share below a minimum amount:
determining, using the processing circuitry, a first number of accounts, from the plurality of accounts, with a pro-rata share below a minimum amount which will not receive an allocation;
updating, using the processing circuitry, at least one of:
a first allocation for at least one account, from the plurality of accounts, with a pro-rata share below the minimum amount which will receive an allocation, such that the first allocation is equal to or greater than the minimum amount, and
a second allocation for at least one account, from the plurality of accounts, with a pro-rata share greater than the minimum amount, such that the second allocation is greater than the minimum amount but less than the pro-rata share for the at least one account,
wherein the updating is based on minimizing a total deviation from the pro-rata allocation of the orders for the financial instrument, and maximizing a number of accounts which receive an allocation.

2. The method of claim 1, wherein the determining, using the processing circuitry, the first number of accounts, from the plurality of accounts, with a pro-rata share below a minimum amount which will not receive an allocation further comprises:
computing a first contribution to the total deviation, from the first number of accounts, from the plurality of accounts, with a pro-rata share below a minimum amount which will not receive an allocation;
computing a second contribution to the total deviation from the at least one account, from the plurality of accounts, with a pro-rata share greater than the minimum amount;
computing a third contribution to the total deviation which is an absolute value of the first contribution to the total deviation minus the second contribution to the total deviation;
determining a fourth contribution to the total deviation which is equal to a set amount when the second contribution minus the first contribution is strictly greater than an amount available for allocation from accounts, of the plurality of accounts, with a pro-rata share above the minimum amount, and which is equal to zero otherwise; and
selecting the first number such that a sum of the first contribution, the second contribution, the third contribution, and the fourth contribution is minimized.

3. The method of claim 1, further comprising:
determining whether the trade is a sell; and
based on the determining that the trade is a sell, performing the updating such that for each of the accounts which receive an allocation, an amount of orders remaining after allocation is greater than the minimum amount.

4. The method of claim 1, further comprising:
determining whether the financial instrument is a Municipal New Issue Bond; and
based on the determining that the financial instrument is a Municipal New Issue Bond, determining a number of CUSIPs available for allocation;
determining whether an allocation to one of the plurality of accounts of the number of CUSIPs available is possible; and
based on determining that the allocation to one of the plurality of accounts of the number of CUSIPs available is possible;
accessing a database linking account level minimums to break points;
determining account level minimums for the plurality of accounts;
based on the accessing and the determined account level minimums, performing the updating such that a number of unique CUSIP and account combinations is minimized.

5. The method of claim 1, further comprising:
transmitting, using the processing circuitry, an allocation of the orders for the financial instrument to a trading system for execution.

6. The method of claim 5, wherein the processing circuitry is part of an allocation module located on a first server, and wherein the trading system is located on a second server.

7. The method of claim 1, wherein the updating is based on multiple executions, such that a fill size of the trade is maximized.

8. The method of claim 1, further comprising, based on the determining that there are accounts, from the plurality of accounts, with a pro-rata share below a minimum amount:
transmitting to an optimization module constraints associated with the financial instrument, the plurality of accounts for trading and associated constraints;
receiving from the optimization module a number of accounts, from the plurality of accounts with a pro-rata share below the minimum amount, for which an allocation will be updated; and
receiving from the optimization module a number of accounts, from the plurality of accounts with a pro-rata share greater than the minimum amount, for which an allocation will be updated.

9. The method of claim 1, wherein the minimizing a total deviation from the pro-rata allocation of the orders for the financial instrument, and the maximizing a number of accounts which receive an allocation are based on multiple allocations.

10. The method of claim 1, further comprising a first plurality of allocations, wherein the first allocation and the second allocation belong to the first plurality of allocations associated with the plurality of accounts;
receiving by the processing circuitry a second plurality of allocations associated with the plurality of accounts;
calculating, using the processing circuitry, a plurality of differences between the first plurality of allocations and the second plurality of allocations;
comparing, using the processing circuitry, each of the plurality of differences to a threshold; and
generating a notification signal based on whether a difference of the plurality of differences exceeds the threshold.

11. A system for allocating trades in a financial instrument between client accounts, the system comprising:
a database; and
processing circuitry configured to:
determine a financial instrument for a trade;
determine a plurality of accounts for trading in the financial instrument;
aggregate orders for the financial instrument from the plurality of accounts;
determine a pro-rata allocation of the orders for the financial instrument, from the plurality of accounts;
determine whether there are accounts, from the plurality of accounts, with a pro-rata share below a minimum amount;
based on the determining that there are accounts, from the plurality of accounts, with a pro-rata share below a minimum amount:
determine a first number of accounts, from the plurality of accounts, with a pro-rata share below a minimum amount which will not receive an allocation;
update at least one of:
a first allocation for at least one account, from the plurality of accounts, with a pro-rata share below the minimum amount which will receive an allocation, such that the first allocation is equal to or greater than the minimum amount, and
a second allocation for at least one account, from the plurality of accounts, with a pro-rata share greater than the minimum amount, such that the second allocation is greater than the minimum amount but less than the pro-rata share for the at least one account,
wherein the updating is based on minimizing a total deviation from the pro-rata allocation of the orders for the financial instrument, and maximizing a number of accounts which receive an allocation.

12. The system of claim 11, wherein the processing circuitry configured to determine, using the processing circuitry, the first number of accounts, from the plurality of accounts, with a pro-rata share below a minimum amount which will not receive an allocation is further configured to:
compute a first contribution to the total deviation, from the first number of accounts, from the plurality of accounts, with a pro-rata share below a minimum amount which will not receive an allocation;
compute a second contribution to the total deviation from the at least one account, from the plurality of accounts, with a pro-rata share greater than the minimum amount;
compute a third contribution to the total deviation which is an absolute value of the first contribution to the total deviation minus the second contribution to the total deviation;
determine a fourth contribution to the total deviation which is equal to a set amount when the second contribution minus the first contribution is strictly greater than an amount available for allocation from accounts, of the plurality of accounts, with a pro-rata share above the minimum amount, and which is equal to zero otherwise; and
select the first number such that a sum of the first contribution, the second contribution, the third contribution, and the fourth contribution is minimized.

13. The system of claim 11, the processing circuitry further configured to:
determine whether the trade is a sell; and
based on the determining that the trade is a sell, perform the updating such that for each of the accounts which receive an allocation, an amount of orders remaining after allocation is greater than the minimum amount.

14. The system of claim 11, the processing circuitry further configured to:
determine whether the financial instrument is a Municipal New Issue Bond; and
based on the determining that the financial instrument is a Municipal New Issue Bond, determine a number of CUSIPs available for allocation;
determine whether an allocation to one of the plurality of accounts of the number of CUSIPs available is possible; and
based on determining that the allocation to one of the plurality of accounts of the number of CUSIPs available is possible;
access a database linking account level minimums to break points;
determine account level minimums for the plurality of accounts;
based on the accessing and the determined account level minimums, perform the updating such that a number of unique CUSIP and account combinations is minimized.

15. The system of claim 11, the processing circuitry further configured to:
transmit, using the processing circuitry, an allocation of the orders for the financial instrument to a trading system for execution.

16. The system of claim 15, wherein the processing circuitry is part of an allocation module located on a first server, and wherein the trading system is located on a second server.

17. The system of claim 11, wherein the updating is based on multiple executions, such that a fill size of the trade is maximized.

18. The system of claim 11, the processing circuitry configured to determine that there are accounts, from the plurality of accounts, with a pro-rata share below a minimum amount further configured to:
transmit to an optimization module constraints associated with the financial instrument, the plurality of accounts for trading and associated constraints;
receive from the optimization module a number of accounts, from the plurality of accounts with a pro-rata share below the minimum amount, for which an allocation will be updated; and
receive from the optimization module a number of accounts, from the plurality of accounts with a pro-rata share greater than the minimum amount, for which an allocation will be updated.

19. The system of claim 11, wherein the minimizing a total deviation from the pro-rata allocation of the orders for the financial instrument, and the maximizing a number of accounts which receive an allocation are based on multiple allocations.

20. The system of claim 11, further comprising a first plurality of allocations, wherein the first allocation and the second allocation belong to the first plurality of allocations associated with the plurality of accounts, the processing circuitry further configured to:
receive by the processing circuitry a second plurality of allocations associated with the plurality of accounts;
calculate, using the processing circuitry, a plurality of differences between the first plurality of allocations and the second plurality of allocations;
compare, using the processing circuitry, each of the plurality of differences to a threshold; and
generate a notification signal based on whether a difference of the plurality of differences exceeds the threshold.
